(19) United States
(12) Patent Application Publication
(10) Pub. No.: US 2026/0261113 A1
(43) Pub. Date: Sep. 3, 2026

(54) FAULT RESPONSE CONTROL IN POWER CONVERTERS

(71) Applicant: Texas Instruments Incorporated, Dallas, TX (US)

(72) Inventors: Florian Schimkat, Freising (DE); Puneet Sareen, Freising (DE); Narayanan Seetharaman, Freising (DE); Christian Mathias Rott, Garching (DE); Uwe Ratzmann, Freising (DE)

(21) Appl. No.: 19/314,325

(22) Filed: Aug. 29, 2025

Related U.S. Application Data
(60) Provisional application No. 63/764,742, filed on Feb. 28, 2025.

(51) Int. Cl. H02H 3/28; G05F 1/46; G05F 1/573; H02M 1/00; H02M 1/088; H02M 1/32

(52) U.S. Cl. CPC H02H 3/28; G05F 1/468; G05F 1/573; H02M 1/0025; H02M 1/0029; H02M 1/088; H02M 1/325; H02M 1/327

(57) ABSTRACT

An example power converter controller includes a driver having a first input and a second input. The power converter controller includes a comparator having a first input coupled to an output voltage feedback terminal, a second input coupled to an input voltage terminal, and an output. The power converter controller includes logic circuitry having a fault input, a second input coupled to the output of the comparator, a first output coupled to the first input of the driver, and a second output coupled to the second input of the driver, the logic circuitry capable of: receiving, at the fault input, a first signal that indicates a fault event, and responsively providing a first control signal to the driver to disable a transistor of a power converter; receiving a second signal from the comparator indicating an input voltage of the power converter exceeds an output voltage of the power converter; and responsive to the first signal and to the second signal, providing a second control signal to the driver to enable the transistor of the power converter.

### CROSS-REFERENCE TO RELATED APPLICATION

This patent application claims the benefit of and priority to U.S. Provisional Patent Application No. 63/764,742 filed Feb. 28, 2025, which is hereby incorporated herein by reference in its entirety.

### TECHNICAL FIELD

This description relates generally to power electronics and, more particularly, to fault response control in power converters.

### BACKGROUND

Power converters are electronic devices that transform electrical energy from one form to another, for example, by changing voltage levels, current levels, or the type of current (alternating current (AC) to direct current (DC), DC to AC, or varying frequency). Power converters play a crucial role in optimizing power delivery and ensuring compatibility between power sources and electronic devices. There are several types of power converters, including DC-DC converters (used in battery-powered devices and electric vehicles), AC-DC converters or rectifiers (used in power supplies for consumer electronics), DC-AC converters or inverters (used in solar power systems and uninterruptible power supplies), and AC-AC converters (used in motor speed controls and frequency converters). Power converters are widely applied in renewable energy systems, electric transportation, consumer electronics, industrial automation, and telecommunication infrastructure, enabling efficient energy usage and system flexibility across various technologies.

### SUMMARY

For systems, methods, and apparatus for fault response control in power converters, an example power converter controller includes a driver having a first input and a second input. The power converter controller includes a comparator having a first input coupled to an output voltage feedback terminal, a second input coupled to an input voltage terminal, and an output. The power converter controller includes logic circuitry having a fault input, a second input coupled to the output of the comparator, a first output coupled to the first input of the driver, and a second output coupled to the second input of the driver, the logic circuitry capable of: receiving, at the fault input, a first signal that indicates a fault event, and responsively providing a first control signal to the driver to disable a transistor of a power converter; receiving a second signal from the comparator indicating an input voltage of the power converter exceeds an output voltage of the power converter; and responsive to the first signal and to the second signal, providing a second control signal to the driver to enable the transistor of the power converter. Other examples are described.

For systems, methods, and apparatus for fault response control in power converters, an example power converter circuit includes a first transistor having a control terminal, a first terminal, and a second terminal. The power converter circuit includes a second transistor having a control terminal, a first terminal coupled to the second terminal of the first transistor, and a second terminal coupled to a first reference voltage terminal. The power converter circuit includes a controller having a first output coupled to the control terminal of the first transistor and a second output coupled to the control terminal of the second transistor, the controller including: a driver having a first input, a second input, a first output coupled to the control terminal of the first transistor, and a second output coupled to the control terminal of the second transistor; control logic circuitry having a first input, a second input, a third input, a first output coupled to the first input of the driver, and a second output coupled to the second input of the driver; fault logic circuitry having an input, a first output coupled to the first input of the control logic circuitry, and a second output coupled to the second input of the control logic circuitry; a first comparator having a first input coupled to an output voltage feedback terminal, a second input coupled to an input voltage terminal, and an output coupled to the input of the fault logic circuitry; a second comparator having a first input coupled to a first sense terminal, a second input coupled to a second sense terminal, and an output; slope compensation circuitry having an output; a mixer having a first input coupled to the output of the second comparator, a second input coupled to the output of the slope compensation circuitry, and an output; a third comparator having a first input coupled to the output of the mixer, a second input, and an output coupled to the third input of the control logic circuitry; and an amplifier having a first input coupled to a second reference voltage terminal, a second input coupled to the output voltage feedback terminal, and an output coupled to the second input of the third comparator. Other examples are described.

For systems, methods, and apparatus for fault response control in power converters, an example system includes a speaker having an input. The system includes an audio amplifier having an input and an output coupled to the input of the speaker. The system includes a power converter having an output coupled to the input of the audio amplifier, the power converter including: a first transistor having a control terminal, a first terminal, and a second terminal; a second transistor having a control terminal, a first terminal coupled to the second terminal of the first transistor, and a second terminal coupled to a reference voltage terminal; an inductor having a first terminal and a second terminal, the first terminal coupled to the second terminal of the first transistor and the first terminal of the second transistor; a driver having a first input, a second input, a first output coupled to the control terminal of the first transistor, and a second output coupled to the control terminal of the second transistor; control logic circuitry having a first input, a second input, a first output coupled to the first input of the driver, and a second output coupled to the second input of the driver; fault logic circuitry having an input, a first output coupled to the first input of the control logic circuitry, and a second output coupled to the second input of the control logic circuitry; and a comparator having a first input coupled to an output voltage feedback terminal, a second input coupled to an input voltage terminal, and an output coupled to the input of the fault logic circuitry. Other examples are described.

### BRIEF DESCRIPTION OF THE DRAWINGS

FIG. 1 is a block diagram of an example power converter including an example output stage and an example controller to control a fault response of one or more transistors of the output stage.

FIG. 2 is a block diagram of the power converter of FIG. 1 depicting a first example implementation of the fault controller circuitry of FIG. 1.

FIG. 3 is an example timing diagram depicting how the controller of FIG. 2 controls a fault response.

FIGS. 4A and 4B (collectively “FIG. 4”) are a block diagram of the power converter of FIG. 1 where the controller includes the fault controller circuitry of FIG. 2, an example soft start switch, and example selection circuitry.

FIG. 5 is an example timing diagram depicting how the controller of FIG. 4 controls a fault response.

FIG. 6 is an example state diagram depicting example states of operation of the controller of FIG. 2 or 3.

FIG. 7 is a flowchart representative of at least one of example machine-readable instructions or example operations that may be at least one of executed, instantiated, or performed by programmable circuitry to implement the controller of FIG. 2 or 3.

FIGS. 8A and 8B (collectively “FIG. 8”) are a block diagram of the power converter of FIG. 1 depicting a second example implementation of the fault controller circuitry of FIG. 1.

FIGS. 9A and 9B (collectively “FIG. 9”) are a block diagram of the power converter of FIG. 1 where the controller includes the fault controller circuitry of FIG. 8, an example soft start switch, and example selection circuitry.

FIG. 10 is an example state diagram depicting example states of operation of the controller of FIG. 8 or 9.

FIGS. 11A and 11B (collectively FIG. 11) are a flowchart representative of at least one of example machine-readable instructions or example operations that may be at least one of executed, instantiated, or performed by programmable circuitry to implement the controller of FIG. 8 or 9.

FIG. 12 is a block diagram of an example system including an example power converter.

FIG. 13 is a block diagram of an example processing platform including programmable circuitry structured to execute, instantiate, or perform the example machine-readable instructions or perform the example operations of FIG. 7 or 11 to implement the controller of any of FIGS. 1, 2, 4, 8, or 9.

The drawings are not necessarily to scale. Generally, the same reference numbers in the drawing(s) and this description refer to the same or similar (in terms of at least one of functional or structural) features or parts.

### DETAILED DESCRIPTION

Various types of transistors may be used as switches in a power converter depending on the application in which the power converter is used. For example, metal-oxide-semiconductor field-effect transistors (MOSFETs) provide efficient power conversion in high-voltage, high-frequency applications. Also, for example, bipolar junction transistors (BJTs) provide high current-carrying capability, making BJTs useful in low-frequency, high-current applications. Insulated gate bipolar transistors (IGBTs) can operate at high voltages and provide high-current carrying capability, making IGBTs useful in high-voltage, high-current, and moderate-frequency applications.

Field-effect transistors (FETs) can be based on a variety of semiconductors such as Silicon (Si) and Gallium Nitride (GaN). In general, Si FETs are designed for lower voltage applications than GaN FETs such as battery management, lower power DC-DC converters, and general-purpose switching, among others. An Si FET is enabled (or turned on) in the forward direction (forward biased) and conducts current when the gate-to-source voltage (V_{GS}) of the Si FET is greater than a threshold voltage (Vₜₕ) (the Si FET is enabled when V_{GS}>Vₜₕ). As a byproduct of the structure of Si FETs, Si FETs include an intrinsic body diode allowing Si FETs to be “enabled” in the reverse direction (reverse biased) and conduct current.

GaN FETs provide increased efficiency at higher frequencies and have lower on-resistance and capacitance than Si FETs. Also, GaN FETs have higher breakdown voltages and higher thermal performance than Si FETs. As such, GaN FETs can be utilized in higher voltage applications than Si FETs such as electric vehicle (EV) chargers, 5^{th} generation (5G) base stations, and aerospace power systems, among others. A GaN FET is enabled (or turned on) in the forward direction (forward biased) and conducts current when the gate-to-source voltage (V_{GS}) of the GaN FET is greater than a threshold voltage (Vₜₕ) (the GaN FET is enabled when V_{GS}>Vₜₕ). As a byproduct of the structure of GaN FETs, GaN FETs do not include an intrinsic body diode but are bi-directional conducting devices. As such, GaN FETs can conduct current when reverse biased.

As described above, Si FETs include an intrinsic body diode that can conduct current when an Si FET is reverse biased. For example, when the source-to-drain voltage (V_{SD}) of an Si FET is large enough to forward bias the intrinsic body diode, the Si FET is reverse biased and conducts current through the intrinsic body diode. As such, when an Si FET is reverse biased, the voltage across the Si FET is set by the voltage across the intrinsic body diode of the Si FET, which is about 0.7V. As described above, GaN FETs are bi-directional conducting devices allowing GaN FETs to conduct current when reverse biased. For example, when the gate-to-drain voltage (V_{GD}) of a GaN FET is greater than the threshold voltage (Vₜₕ) of the GaN FET, the GaN FET is enabled in the reverse direction (reverse biased) and conducts current.

Because GaN FETs do not include an intrinsic body diode, the voltage across a reverse biased GaN FET is not clamped to below 1V like in a reverse biased Si FET. Instead, the voltage across a reverse biased GaN FET is set based on (1) the difference between the threshold voltage (Vₜₕ) and the gate-to-source voltage (V_{GS}) and (2) the product of the “on” resistance of the GaN FET when reverse biased and the amount of current flowing through the GaN FET. The “on” resistance of a GaN FET when reverse biased depends on the amount of current flowing through the GaN FET. Thus, the voltage across a reverse biased GaN FET, also referred to as the source-to-drain voltage (V_{SD}), varies based on the amount of current through the reverse biased GaN FET. The voltage across a reverse biased GaN FET can be as high as 2V.

Power converters include controllers to monitor, control, and protect components of the power converters such as transistors. For example, a controller will shut down or disable a power converter (also referred to as a power converter circuit) when a fault such as an overcurrent fault or an overtemperature fault is detected. Thus, the transistors of a power converter will be disabled (or turned off) after a fault is detected. Depending on the architecture of a power converter, the output voltage from the power converter may fall below the input voltage to the power converter when disabled. As a result, one or more transistors of the power converter may be reverse biased. For example, when a boost converter is disabled, the inductor of the boost converter discharges and pulls the output voltage from the power converter below the input voltage to the power converter. Because the output voltage from the boost converter is less than the input voltage to the boost converter, the high-side transistor of the boost converter is reverse biased.

Load current in power converters can be several amps (A) (for example, 10 s of amps) when a fault such as an overcurrent fault or an overtemperature fault manifests. As such, disabling a transistor in a boost converter responsive to a fault can subject the transistor to potentially damaging conditions depending on the type of transistor used in the boost converter. For example, where a boost converter uses GaN FETs, the GaN FETs can be subjected to damaging conditions when disabled. Whereas Si FETs may not be subjected to damaging conditions when disabled. Namely, the relatively larger voltage drop across a reverse biased GaN FET and the large current through the reverse biased GaN FET can cause the reverse biased GaN FET to dissipate a substantial amount of power that can damage the device (for example, 2V*10 A=20 Watts). Si FETs may not be subjected to such large power dissipation due to the intrinsic body diode of Si FETs which have a relatively lower voltage drop (for example, 0.7V<2V).

To avoid damaging reverse biased GaN FETs, examples described herein enable a GaN FET in the forward direction when the gate-to-drain voltage (V_{GD}) of the GaN FET approaches a condition that could reverse bias the GaN FET. For example, in a boost converter, examples described herein enable a high-side GaN FET in the forward direction responsive to the output voltage from the boost converter falling below the input voltage to the boost converter. As such, the voltage across the GaN FET is much smaller than when reverse biased and even with substantial load current, the power dissipated by the GaN FET is not at a level that can damage the GaN FET.

Examples described herein also differentiate between faults related to control of GaN FETs and faults related to internal supplies of a controller. For example, when a fault such as an overtemperature fault manifests, examples described herein compare a supply voltage to a reference voltage to determine whether the supply voltage is below the reference voltage (indicating a supply fault). In this manner, examples described herein can determine whether a fault such as an overtemperature fault manifested as a result of improper operation of a supply circuit or as a result of improper operation of a power converter, for instance.

Also, after a fault clears, examples described herein set the slew rate for start-up of a power converter by clamping a soft start pin of a controller of the power converter to a voltage level equivalent to a feedback voltage to the controller. In examples described herein, the feedback voltage tracks the input voltage to the power converter when the high-side GaN FET of the power converter is enabled during a fault condition. In this manner, examples described herein provide smooth return to a target voltage after a fault clears in a power converter and limit the input current to the power converter to a target level.

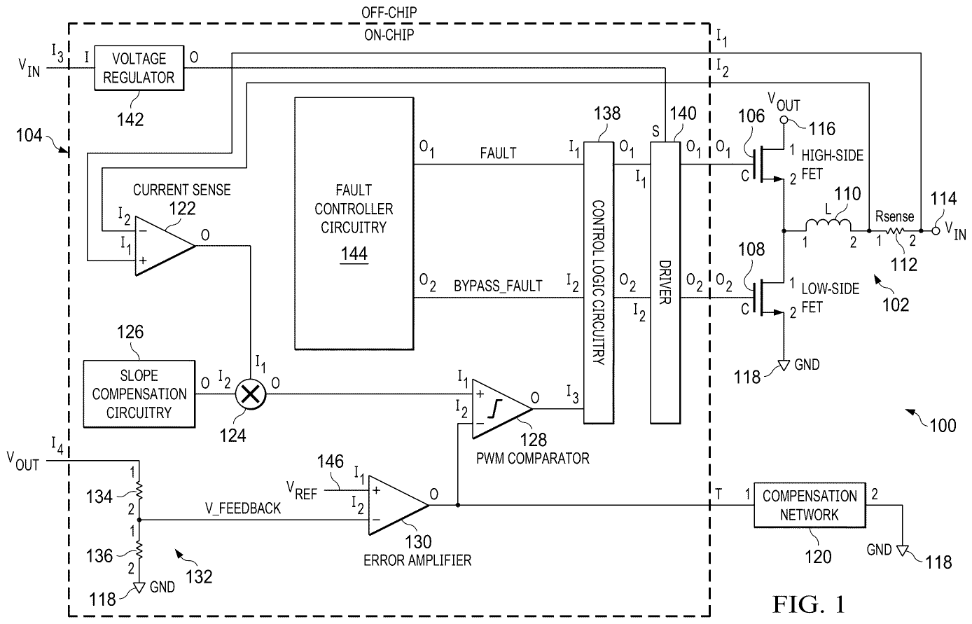

FIG. 1 is a block diagram of an example power converter 100 including an example output stage 102 and an example controller 104 to control a fault response of one or more transistors of the output stage 102. In the example of FIG. 1, the output stage 102 includes an example high-side FET 106 (e.g., a GaN FET), an example low-side FET 108 (e.g., a GaN FET), an example inductor 110, and a first example resistor 112. Also, the power converter 100 receives an input voltage (V_{IN}) at an example input voltage terminal 114 and provides an output voltage (V_{OUT}) at an example output voltage terminal 116. For example, the input voltage (V_{IN}) is provided by a DC power supply such as a battery and the output voltage (V_{OUT}) is provided to a load such as an audio amplifier. In the example of FIG. 1, the input voltage (V_{IN}) and the output voltage (V_{OUT}) are measured with respect to a reference voltage at a first example reference voltage terminal 118 (GND). For example, the reference voltage terminal 118 is a ground terminal.

In the illustrated example of FIG. 1, the high-side FET 106 and the low-side FET 108 are each implemented by a GaN FET. In the example of FIG. 1, the high-side FET 106 and the low-side FET 108 each have a control terminal, a first terminal, and a second terminal. For example, the control terminal is a gate, the first terminal is a drain, and the second terminal is a source. In the example of FIG. 1, the control terminal of the high-side FET 106 is coupled to a first output of the controller 104 and the first terminal of the high-side FET 106 is coupled to the output voltage terminal 116. Also, the second terminal of the high-side FET 106 is coupled to the first terminal of the low-side FET 108 and a first terminal of the inductor 110.

In the illustrated example of FIG. 1, the control terminal of the low-side FET 108 is coupled to a second output of the controller 104 and the first terminal of the low-side FET 108 is coupled to the second terminal of the high-side FET 106 and the first terminal of the inductor 110. Also, the second terminal of the low-side FET 108 is coupled to the reference voltage terminal 118. As described above, the inductor 110 has a first terminal coupled to the second terminal of the high-side FET 106 and the first terminal of the low-side FET 108. The inductor 110 also has a second terminal coupled to a first terminal of the resistor 112.

In the illustrated example of FIG. 1, the first terminal of the resistor 112 is coupled to the second terminal of the inductor 110 and a second input of the controller 104. Also, the resistor 112 has a second terminal coupled to a first input of the controller 104 and the input voltage terminal 114. In the example of FIG. 1, the controller 104 also has a third input coupled to the input voltage terminal 114 and a fourth input coupled to the output voltage terminal 116. For example, the controller 104 receives the input voltage (V_{IN}) at the third input of the controller 104 and receives the output voltage (V_{OUT}) at the fourth input of the controller 104. In examples described herein, the fourth input of the controller 104 is also referred to as a feedback pin, a feedback terminal, or the output voltage feedback terminal of the controller 104. In some examples, the controller 104 receives a different input voltage than the input voltage (V_{IN}) received at the input voltage terminal 114. In additional or alternative examples, the controller 104 has one or more additional inputs or one or more additional outputs.

In the illustrated example of FIG. 1, the controller 104 also has a tuning terminal (T) coupled to a first terminal of an example compensation network 120. For example, the compensation network 120 stabilizes a feedback loop implemented by the controller 104, and may include one or more capacitors or other elements. The example compensation network 120 of FIG. 1 also has a second terminal coupled to the reference voltage terminal 118. In the example of FIG. 1, the controller 104 is implemented in an integrated circuit (IC) and the output stage 102 and the compensation network 120 are implemented externally to the IC. In some examples, one or more components of the output stage 102 or the compensation network 120 (for example, the high-side FET 106 and the low-side FET 108) are implemented in the same package or on the same IC as the controller 104. In some examples, the controller 104 is referred to as a power converter controller.

A variety of power converters exist including boost converters, buck converters, buck-boost converters, inverters, rectifiers, half-bridges, and full-bridges. In the example of FIG. 1, the power converter 100 is a boost converter that steps up or increases the input voltage (V_{IN}) at the input voltage terminal 114. In some examples, the power converter 100 is another type of power converter such as a DC-AC inverter including a half-bridge. In general, power converters can be used in a variety of applications. For example, boost converters are utilized in battery-powered devices to step up voltages, in solar power systems to match panel output voltage, and in light emitting diode (LED) drivers to maintain brightness.

Other applications for power converters include converting AC power to DC power for power supplies. For example, converting AC power to DC power is useful in power supplies in computers, mobile devices, and embedded systems as well as in industrial equipment. Power converters can also be utilized to reduce voltages in power supplies (for example, for downstream components) and to invert DC power to AC power in solar power supplies and uninterruptible power supplies. Other applications for power converters include motor control, motor drives, induction heating, and audio amplifiers.

In the illustrated example of FIG. 1, the controller 104 includes a first example amplifier 122, an example mixer 124, example slope compensation circuitry 126, a second example amplifier 128, and a third example amplifier 130. The example controller 104 of FIG. 1 also includes an example voltage divider 132 that includes a second example resistor 134 and a third example resistor 136. In the example of FIG. 1, the controller 104 includes example control logic circuitry 138 (also referred to as gate control logic circuitry), an example driver 140, and an example voltage regulator 142. The example controller 104 of FIG. 1 also includes example fault controller circuitry 144 to control the output stage 102 responsive to detecting a fault event. In some examples, one or more components of the controller 104 (for example, the voltage divider 132 and the voltage regulator 142) are implemented externally to the controller 104 IC. The voltage regulator 142 can be a low dropout regular, for instance, and is an example of a voltage supply circuit.

In the illustrated example of FIG. 1, the amplifier 122 is a current sensing amplifier (also referred to as a current sensor) that monitors current through the resistor 112 and indicates current through the inductor 110. In the example of FIG. 1, a first input of the amplifier 122 is coupled to the second terminal of the resistor 112 and a second input of the amplifier 122 is coupled to the first terminal of the resistor 112. For example, the first input of the amplifier 122 is coupled to the second terminal of the resistor 112 via the first input of the controller 104 and the second input of the amplifier 122 is coupled to the first terminal of the resistor 112 via the second input of the controller 104. As such, the first input and the second input of the controller 104 are referred to as a first sense terminal and a second sense terminal, respectively, in some examples. Also, the output of the amplifier 122 is coupled to a first input of the mixer 124. In some examples, the amplifier 122 has one or more additional outputs. In the example of FIG. 1, the mixer 124 mixes a ramp signal provided by the slope compensation circuitry 126 with a sensed current signal provided by the amplifier 122. For example, the ramp signal provided by the slope compensation circuitry 126 mitigates sub-harmonic oscillation in the current through the inductor 110.

As described above, the first input of the mixer 124 is coupled to the output of the amplifier 122. Also, the example mixer 124 of FIG. 1 has a second input coupled to an output of the slope compensation circuitry 126 as well as an output coupled to a first input of the amplifier 128. In the example of FIG. 1, the mixer 124 provides a slope compensated sensed current signal to the first input of the amplifier 128. As such, the output of the mixer 124 is referred to as a sense terminal, in some examples. As described above, the first input of the amplifier 128 is coupled to the output of the mixer 124. In the example of FIG. 1, the amplifier 128 also has a second input coupled to an output of the amplifier 130 and the first terminal of the compensation network 120. The example amplifier 128 of FIG. 1 also has an output coupled to a third input of the control logic circuitry 138. In some examples, the output of the amplifier 128 is referred to as a control output. In the example of FIG. 1, the amplifier 128 is a pulse width modulation (PWM) comparator that compares the slope compensated sensed current signal from the mixer 124 to an error signal from the amplifier 130.

In the illustrated example of FIG. 1, the amplifier 130 is an error amplifier that compares a feedback voltage (V_{Feedback}) from the voltage divider 132 to a reference voltage (V_{REF}) at a second example reference voltage terminal 146. For example, a first input of the amplifier 130 is coupled to the reference voltage terminal 146 and a second input of the amplifier 130 is coupled to a second terminal of the resistor 134 and a first terminal of the resistor 136. As such, the first input of the amplifier 130 is referred to as a reference input in some examples. Also, the second input of the amplifier 130 is referred to as a feedback input in some examples.

In the illustrated example of FIG. 1, the reference voltage (V_{REF}) is a target voltage that the power converter 100 is to provide at the output voltage terminal 116. Based on the comparison, the amplifier 130 provides the error signal to the amplifier 128. For example, the output of the amplifier 130 is coupled to the second input of the amplifier 128 and the first terminal of the compensation network 120. As such, the output of the amplifier 130 is referred to as a control output in some examples.

In the illustrated example of FIG. 1, the voltage divider 132 includes the resistor 134 and the resistor 136 as described above. For example, a first terminal of the resistor 134 is coupled to the output voltage terminal 116 and the second terminal of the resistor 134 is coupled to the first terminal of the resistor 136. The second terminal of the resistor 134 is also coupled to the second input of the amplifier 130 as described above. In the example of FIG. 1, the first terminal of the resistor 136 is coupled to the second terminal of the resistor 134 and the second input of the amplifier 130. Also, a second terminal of the resistor 136 is coupled to the reference voltage terminal 118.

As described above, the amplifier 128 is a PWM comparator that compares the slope compensated sensed current signal from the mixer 124 to the error signal provided by the amplifier 130. Based on the comparison, the amplifier 128 generates a PWM signal and provides the PWM signal to the control logic circuitry 138. The PWM signal is used to control the switching of the high-side FET 106 and the low-side FET 108 to generate the output signal V_{OUT}. Responsive to the PWM signal, the control logic circuitry 138 generates a control signal and provides the control signal to the driver 140. In the example of FIG. 1, the control logic circuitry 138 has a first input coupled to a first output of the fault controller circuitry 144 and a second input coupled to a second output of the fault controller circuitry 144. As described above, the third input of the control logic circuitry 138 is coupled to the output of the amplifier 128.

In the illustrated example of FIG. 1, a first output of the control logic circuitry 138 is coupled to a first input of the driver 140 and a second output of the control logic circuitry 138 is coupled to a second input of the driver 140. In some examples, the first output and the second output of the control logic circuitry 138 are referred to as a first driver output and a second driver output, respectively. Also, the first input, the second input, and the third input of the control logic circuitry 138 are referred to as a first control input, a second control input, and a third control input, respectively, in some examples.

In the illustrated example of FIG. 1, a supply terminal of the driver 140 is coupled to an output of the voltage regulator 142. For example, an input of the voltage regulator 142 is coupled to the input voltage terminal 114 of the power converter 100 to receive the input voltage (V_{IN}). Based on the input voltage (V_{IN}), the voltage regulator 142 provides a supply voltage to the driver 140 at the supply terminal of the driver 140. In some examples, the output of the voltage regulator 142 is referred to as a supply output or a supply voltage terminal and the supply terminal of the driver 140 is referred to as a supply input. As described above, the first input of the driver 140 is coupled to the first output of the control logic circuitry 138 and the second input of the driver 140 is coupled to the second output of the control logic circuitry 138. As such, the first input of the driver 140 and the second input of the driver 140 are referred to as a first control input and a second control input, respectively, in some examples.

In the illustrated example of FIG. 1, responsive to a control signal provided by the control logic circuitry 138, the driver 140 controls at least one of the high-side FET 106 or the low-side FET 108. For example, a first output of the driver 140 is coupled to the control terminal of the high-side FET 106, and a second output of the driver 140 is coupled to the control terminal of the low-side FET 108. As such, the first output and the second output of the driver 140 are referred to as a first transistor output and a second transistor output, respectively, in some examples.

As described above, the amplifier 128 is a PWM comparator that provides a PWM signal to the control logic circuitry 138. PWM is a widely adopted control technique used in power converters, particularly in DC-DC and DC-AC power converters. For example, the controller 104 regulates the output voltage (V_{OUT}) and current of the output stage 102 by enabling and disabling (referred to as switching) the high-side FET 106 and the low-side FET 108 at high frequencies and adjusting the duty cycle to control the amount of power delivered to a load. In examples described herein, duty cycle refers to the ratio of “on” time to total cycle time of a switching period.

In the illustrated example of FIG. 1, the first output of the fault controller circuitry 144 is coupled to the first input of the control logic circuitry 138 and the second output of the fault controller circuitry 144 is coupled to the second input of the control logic circuitry 138. In some examples, the fault controller circuitry 144 has one or more inputs or one or more additional outputs. In described examples, the fault controller circuitry 144 protects one or more of the high-side FET 106 or the low-side FET 108 responsive to detecting a fault event. For example, the fault controller circuitry 144 monitors the state of the power converter 100, monitors for an overcurrent event, or monitors for an overtemperature event.

Responsive to a detected fault event, the fault controller circuitry 144 provides a fault signal to the control logic circuitry 138. Responsive to the fault signal, the control logic circuitry 138 provides a first control signal to the driver 140. Responsive to the first control signal, the driver 140 disables the high-side FET 106 and the low-side FET 108. As described above, when the high-side FET 106 and the low-side FET 108 are disabled, the output voltage (V_{OUT}) from the power converter 100 (a boost converter) can fall below the input voltage (V_{IN}) to the power converter 100. If the output voltage (V_{OUT}) falls below the input voltage (V_{IN}), the high-side FET 106 will be reverse biased which can damage the high-side FET 106.

As such, the fault controller circuitry 144 monitors the output voltage (V_{OUT}) from the power converter 100 and the input voltage (V_{IN}) to the power converter 100. Responsive to the output voltage (V_{OUT}) being less than the input voltage (V_{IN}), the fault controller circuitry 144 provides a fault bypass signal to the control logic circuitry 138. Responsive to the fault bypass signal, the control logic circuitry 138 provides a second control signal to the driver 140. Responsive to the second control signal, the driver 140 enables the high-side FET 106 in the forward direction. As such, the voltage across the high-side FET 106 is much smaller than when reverse biased and even with substantial load current, the power dissipated by the high-side FET 106 will not be at a level that can damage the high-side FET 106.

While the fault controller circuitry 144, or, more generally, the controller 104 of FIG. 1 is implemented in a boost converter to protect a GaN FET, the fault controller circuitry 144, or, more generally, the controller 104 is not limited to boost converters. In general, the fault controller circuitry 144 can be implemented in a variety of applications such as power converters and motor drives. In additional or alternative examples, the fault controller circuitry 144 is integrated in the same package as a GaN FET to protect the GaN FET.

In the example of FIG. 1, the high-side FET 106 and the low-side FET 108 may be depletion mode devices and enhancement mode devices. Furthermore, the high-side FET 106 and the low-side FET 108 may be implemented in/over a Gallium-based substrate such as a GaN substrate or a Gallium Arsenide (GaAs) substrate. Other implementations of the high-side FET 106 and the low-side FET 108 are possible. For example, the high-side FET 106 and the low-side FET 108 may implemented in/over a non-Gallium-based substrate such as a silicon (Si) substrate, a silicon-carbide (SiC) substrate, or a diamond substrate.

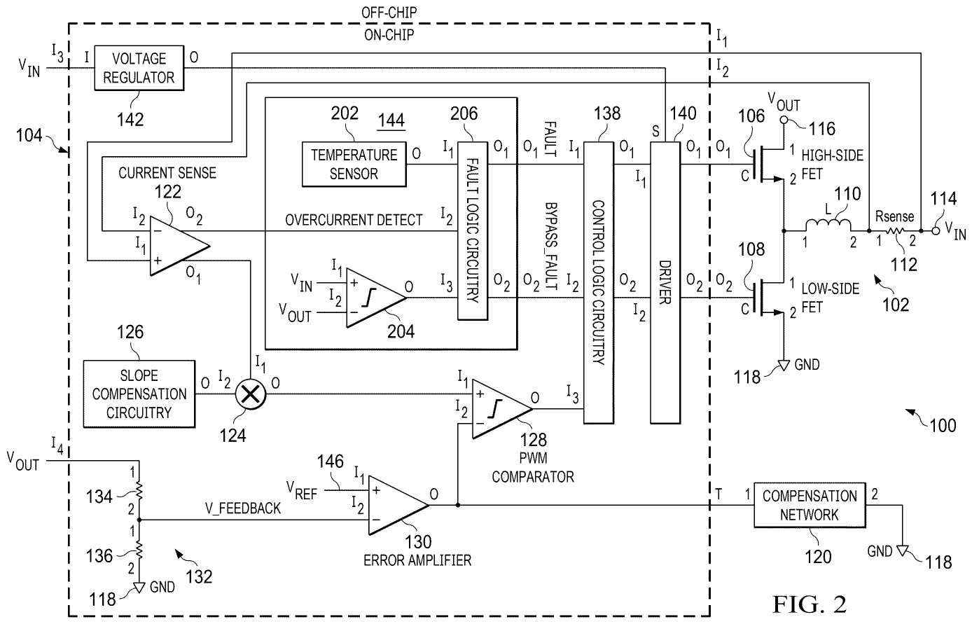

FIG. 2 is a block diagram of the power converter 100 of FIG. 1 depicting a first example implementation of the fault controller circuitry 144 of FIG. 1. The example fault controller circuitry 144 of FIG. 2 includes an example temperature sensor 202, an example amplifier 204, and example fault logic circuitry 206. In the example of FIG. 2, the temperature sensor 202 has an output, the amplifier 204 has a first input, a second input, and an output, and the fault logic circuitry 206 has a first input, a second input, a third input, a first output, and a second output. Also, in the example of FIG. 2, the amplifier 122 has a first output and a second output. For example, the first output of the amplifier 122 is coupled to the first input of the mixer 124.

In the illustrated example of FIG. 2, the output of the temperature sensor 202 is coupled to the first input of the fault logic circuitry 206. In the example of FIG. 2, the first input of the amplifier 204 is coupled to the input voltage terminal 114 of the power converter 100. For example, the amplifier 204 receives the input voltage (V_{IN}) to the power converter 100 at the first input. In the example of FIG. 2, the second input of the amplifier 204 is coupled to the output voltage terminal 116 of the power converter 100. For example, the amplifier 204 receives the output voltage (V_{OUT}) from the power converter 100 at the second input. Also, the output of the amplifier 204 is coupled to the third input of the fault logic circuitry 206.

In the illustrated example of FIG. 2, the first input of the fault logic circuitry 206 is coupled to the output of the temperature sensor 202. In the example of FIG. 2, the second input of the fault logic circuitry 206 is coupled to the second output of the amplifier 122. Also, the third input of the fault logic circuitry 206 is coupled to the output of the amplifier 204 as described above. In the example of FIG. 2, the first output of the fault logic circuitry 206 is coupled first input of the control logic circuitry 138. Also, the second output of the fault logic circuitry 206 is coupled to the second input of the control logic circuitry 138.

In the illustrated example of FIG. 2, the temperature sensor 202 is implemented by circuitry including a semiconductor device such as a BJT. For example, the base-to-emitter voltage (V_{BE}) of a BJT varies predictably with temperature. As such, by monitoring the base-to-emitter voltage (V_{BE}) of a BJT, the temperature sensor 202 can monitor the temperature of a circuit in which the BJT is implemented, which, in the example of FIG. 2, is the power converter 100. If the temperature of the power converter 100 exceeds a temperature threshold (indicating an overtemperature fault has manifested), the temperature sensor 202 provides a sensor signal to the fault logic circuitry 206. For example, responsive to a fault, the temperature sensor 202 asserts the sensor signal. As such, the temperature sensor 202 is referred to as overtemperature detection circuitry, in some examples. Also, the sensor signal provided by the temperature sensor 202 is referred to as a fault signal, in some examples, as the sensor signal indicates a fault event has manifested.

In examples described herein, a signal is asserted when the signal is in an active state. In examples described herein, the active state of a signal is the logic value at which the signal communicates the presence of a certain state. For example, the sensor signal from the temperature sensor 202 is in an active state when the sensor signal communicates the presence of a temperature fault. Also, an asserted signal can be re-asserted without first de-asserting the signal. For example, if the temperature of the power converter 100 continues to exceed the temperature threshold, the temperature sensor 202 continues to assert the sensor signal. In examples described herein, a signal being asserted does not necessarily imply the signal has a logic high value. For example, while an active-high signal is asserted when the logic value of the signal is high, an active-low signal is asserted when the logic value of the signal is low.

In examples described herein, a signal is de-asserted when the signal is in an inactive state. In examples described herein, the inactive state of a signal is the logic value at which the signal communicates the absence of a certain state. For example, the sensor signal from the temperature sensor 202 is in an inactive state when the sensor signal communicates the absence of a temperature fault. Also, a de-asserted signal can be re-de-asserted without first asserting the signal. For example, if the temperature of the power converter 100 continues to be below the temperature threshold, the temperature sensor 202 continues to de-assert the sensor signal. In examples described herein, a signal being de-asserted does not necessarily imply that the signal has a logic low value. For example, while an active-high signal is de-asserted when the logic value of the signal is low, an active-low signal is de-asserted when the logic value of the signal is high.

In the illustrated example of FIG. 2, the amplifier 122 is implemented by circuitry including one or more operational amplifiers (op-amps). As described above, the amplifier 122 monitors current through the resistor 112 and provides a sensed current signal to the mixer 124. The amplifier 122 also compares the sensed current to a current threshold. If the sensed current through the resistor 112 exceeds the current threshold (indicating an overcurrent fault has manifested), the amplifier 122 provides a sensor signal to the fault logic circuitry 206. For example, responsive to a fault, the amplifier 122 asserts the sensor signal. As such, the amplifier 122 is referred to as overcurrent detection circuitry or is an overcurrent comparator, in some examples. Also, the sensor signal provided by the amplifier 122 is referred to as a fault signal, in some examples, as the sensor signal indicates a fault event has manifested. In additional or alternative examples, the controller 104 or the fault logic circuitry 206 includes one or more additional sensors to monitor for one or more additional or alternative faults such as overvoltage faults or undervoltage faults, among others.

As described above, when a fault manifests in the power converter 100, a sensor monitoring for the fault (the temperature sensor 202, the amplifier 122, etc.) provides a sensor signal to the fault logic circuitry 206. In the example of FIG. 2, the fault logic circuitry 206 is implemented by programmable circuitry as described herein. As described above, the first input of the fault logic circuitry 206 is coupled to the output of the temperature sensor 202 and the second input of the fault logic circuitry 206 is coupled to the second output of the amplifier 122. As such, the first input and the second input of the fault logic circuitry 206 are referred to as a first sensor input and a second sensor input, respectively, in some examples. In some examples, the first input and the second input of the fault logic circuitry 206 are referred to as a first fault input and a second fault input, respectively.

In the illustrated example of FIG. 2, responsive to a sensor signal, the fault logic circuitry 206 provides a fault signal to the control logic circuitry 138. For example, responsive to an asserted sensor signal, the fault logic circuitry 206 asserts the fault signal and provides the fault signal via the first output of the fault logic circuitry 206. As such, the first output of the fault logic circuitry 206 is referred to as a fault output in some examples. Responsive to the fault signal, the control logic circuitry 138 provides a first control signal to the driver 140. For example, responsive to an asserted fault signal, the control logic circuitry 138 de-asserts the first control signal. Responsive to the first control signal, the driver 140 disables the high-side FET 106 and the low-side FET 108.

In examples described herein, a transistor is disabled when the control voltage of the transistor is at a level that does not cause the transistor to conduct current. For example, a transistor is disabled when the transistor is in a cutoff mode of operation. In examples described herein, a transistor is enabled when the control voltage of the transistor is at a level to cause the transistor to conduct current. For example, a transistor is enabled when the transistor is in a linear mode of operation or a saturation mode of operation. In examples described herein, the control voltage to forward bias a negative channel (N-channel) Si FET is the gate-to-source voltage (V_{GS}), the control voltage to forward bias a positive channel (P-channel) Si FET is the source-to-gate (V_{SG}), the control voltage to forward bias a GaN FET is the gate-to-source voltage (V_{GS}), and the control voltage to reverse bias a GaN FET is the gate-to-drain voltage (V_{GD}).

In the illustrated example of FIG. 2, the amplifier 204 is implemented by circuitry including one or more op-amps. In the example of FIG. 2, the first input of the amplifier 204 is a non-inverting input and the second input of the amplifier 204 is an inverting input. As described above, the first input of the amplifier 204 is coupled to the input voltage terminal 114 of the power converter 100 and the second input of the amplifier 204 is coupled to the output voltage terminal 116 of the power converter 100. As such, the first input and the second input of the amplifier 204 are referred to as a first power converter input and a second power converter input, respectively, in some examples.

In the illustrated example of FIG. 2, the amplifier 204 is a transistor protection comparator that compares the input voltage at the first power converter input to the output voltage at the second power converter input. In the example of FIG. 2, the amplifier 204 provides a transistor protection signal to the third input of the fault logic circuitry 206 based on the comparison. As such, the output of the amplifier 204 is referred to as a control output in some examples. In the example of FIG. 2, if the input voltage (V_{IN}) is greater than or equal to the output voltage (V_{OUT}), the amplifier 204 asserts the transistor protection signal. In other words, if the output voltage (V_{OUT}) is less than or equal to the input voltage (V_{IN}), the amplifier 204 asserts the transistor protection signal. Otherwise, if the input voltage (V_{IN}) is less than the output voltage (V_{OUT}), the amplifier 204 de-asserts the transistor protection signal. In other words, if the output voltage (V_{OUT}) is greater than the input voltage (V_{IN}), the amplifier 204 de-asserts the transistor protection signal.

As described above, the third input of the fault logic circuitry 206 is coupled to the output of the amplifier 204. As such, the third input of the fault logic circuitry 206 is referred to as a transistor protection input in some examples. In the example of FIG. 2, responsive to the transistor protection signal, the fault logic circuitry 206 provides a fault bypass signal to the control logic circuitry 138. For example, responsive to an asserted transistor protection signal, the fault logic circuitry 206 asserts the fault bypass signal and provides the fault bypass signal at the second output of the fault logic circuitry 206. As such, the second output of the fault logic circuitry 206 is referred to as a fault bypass output in some examples.

Responsive to the fault bypass signal, the control logic circuitry 138 provides a second control signal to the driver 140. For example, responsive to an asserted fault bypass signal, the control logic circuitry 138 asserts the second control signal. Responsive to the second control signal, the driver 140 enables the high-side FET 106 in the forward direction. As such, the high-side FET 106 is not reverse biased even though the output voltage (V_{OUT}) from the power converter 100 was less than the input voltage (V_{IN}) to the power converter 100. Thus, the high-side FET 106 does not dissipate power to a level that could damage the high-side FET 106.

In the illustrated example of FIG. 2, responsive to a fault clearing, a sensor monitoring the fault de-asserts a sensor signal provided to the fault logic circuitry 206. For example, responsive to an overtemperature fault clearing (the temperature of the power converter 100 falling below the temperature threshold), the temperature sensor 202 de-asserts the sensor signal provided to the fault logic circuitry 206. Also, for example, responsive to an overcurrent fault clearing (the current through the resistor 112 falls below the current threshold), the amplifier 122 de-asserts the sensor signal provided to the fault logic circuitry 206.

In the illustrated example of FIG. 2, responsive to a de-asserted sensor signal, the fault logic circuitry 206 de-asserts the fault signal and the fault bypass signal. In the example of FIG. 2, responsive to the de-asserted fault signal and the de-asserted fault bypass signal, the control logic circuitry 138 de-asserts the second control signal to the driver 140. Responsive to the de-asserted second control signal, the driver 140 disables the high-side FET 106. As such, the power converter 100 can return to normal operation as dictated by the feedback loop and PWM control implemented by the controller 104.

As described above, the fault controller circuitry 144 protects the high-side FET 106 in the event that the high-side FET 106 is disabled responsive to a manifested fault. Example faults include overtemperature and overcurrent faults as well as overvoltage and undervoltage faults. In some examples, the fault controller circuitry 144 disables the high-side FET 106, or, more generally, the power converter 100 responsive to more than one fault. For example, an overcurrent fault (sensed by the amplifier 122) may cause the temperature of the power converter 100 to increase and induce an overtemperature fault (sensed by the temperature sensor 202). An overvoltage fault may induce an overtemperature fault as well. As such, the fault controller circuitry 144 protects the high-side FET 106 responsive to a variety of faults individually or in combination.

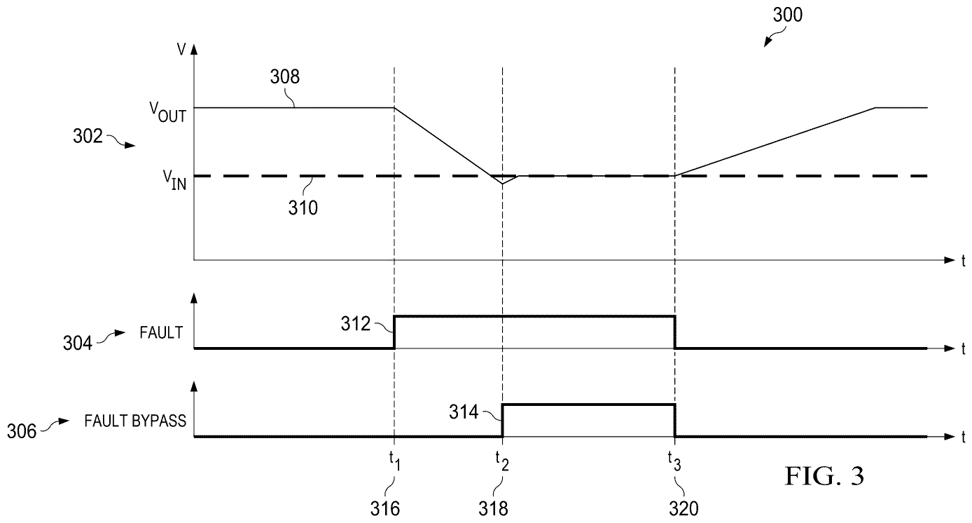

FIG. 3 is an example timing diagram 300 depicting how the controller 104 of FIG. 2 controls a fault response. In the example of FIG. 3, the timing diagram 300 includes a first example graph 302, a second example graph 304, and a third example graph 306. The graph 302 depicts a first example plot 308 of the output voltage (V_{OUT}) from the power converter 100 and a second example plot 310 of the input voltage (V_{IN}) to the power converter 100 in volts versus time. Also, the graph 304 depicts a third example plot 312 of the fault signal provided by the fault logic circuitry 206 as a binary signal versus time. The graph 306 depicts a fourth example plot 314 of the fault bypass signal provided by the fault logic circuitry 206 as a binary signal versus time.

In the illustrated example of FIG. 3, before a first example time 316 (t₁), the controller 104 is in a normal state of operation. For example, before the time 316 (t₁), the controller 104 regulates the high-side FET 106 and the low-side FET 108 to step-up the input voltage (V_{IN}) to a target output voltage (V_{OUT}) based on the reference voltage (V_{REF}) at the reference voltage terminal 146. At the time 316 (t₁), the controller 104 detects a fault and disables the high-side FET 106 and the low-side FET 108. For example, if the temperature sensor 202 detects that the temperature of the power converter 100 exceeds the temperature threshold, the temperature sensor 202 asserts a sensor signal. Responsive to the asserted sensor signal, the fault logic circuitry 206 asserts the fault signal (the plot 312) which causes the controller 104 to disable the high-side FET 106 and the low-side FET 108.

For example, responsive to the asserted fault signal, the control logic circuitry 138 de-asserts a first control signal. Responsive to the de-asserted first control signal, the driver 140 disables the high-side FET 106 and the low-side FET 108. As such, after the time 316 (t₁), the output voltage (V_{OUT}) from the power converter 100 (the plot 308) begins to decrease. As described above, the amplifier 204 continues to monitor the output voltage (V_{OUT}) (the plot 308) and the input voltage (V_{IN}) (the plot 310). At a second example time 318 (t₂), the controller 104 detects that the output voltage (V_{OUT}) is less than the input voltage (V_{IN}) and enables the high-side FET 106. For example, if the amplifier 204 detects that the output voltage (V_{OUT}) is less than the input voltage (V_{IN}), the amplifier 204 asserts a transistor protection signal. Responsive to the asserted transistor protection signal, the fault logic circuitry 206 asserts the fault bypass signal (the plot 314) which causes the controller 104 to enable the high-side FET 106.

For example, responsive to the asserted fault bypass signal, the control logic circuitry 138 asserts a second control signal. Responsive to the asserted second control signal, the driver 140 enables the high-side FET 106. As such, after the time 318 (t₂), the high-side FET 106 is enabled, and the output voltage (V_{OUT}) (the plot 308) is approximately equal to the input voltage (V_{IN}) (the plot 310). As such, the controller 104 ensures that the voltage drop across the high-side FET 106 is defined by the “on” resistance of the high-side FET 106 and thus, far lower than the reverse bias voltage drop across the high-side FET 106. For example, if the “on” resistance of the high-side FET 106 is five milliohms (R_{DS}=5 mΩ) and the load current is 10 A (I_{LOAD}=10 A), then the power dissipated by the high-side FET 106 is 500 milliwatts (P=R_{DS}*I_{LOAD}=500 mW) which is much less than the 20 Watts that the high-side FET 106 would dissipate if reverse biased.

In the illustrated example of FIG. 3, at a third example time 320 (t₃), the controller 104 detects that the fault has cleared. For example, the temperature sensor 202 detects that the temperature of the power converter 100 is less than the temperature threshold and de-asserts the sensor signal. Responsive to the de-asserted sensor signal, the fault logic circuitry 206 de-asserts the fault signal (the plot 312) and the fault bypass signal (the plot 314). Responsive to the de-asserted fault signal and the de-asserted fault bypass signal, the control logic circuitry 138 de-asserts the second control signal. Responsive to the de-asserted second control signal, the driver 140 disables the high-side FET 106. As such, the controller 104 can return to normal operation after the time 320 (t₃). For example, after the time 320 (t₃), the controller 104 regulates the high-side FET 106 and the low-side FET 108 to step-up the input voltage (V_{IN}) to a target output voltage (V_{OUT}) based on the reference voltage (V_{REF}) at the reference voltage terminal 146.

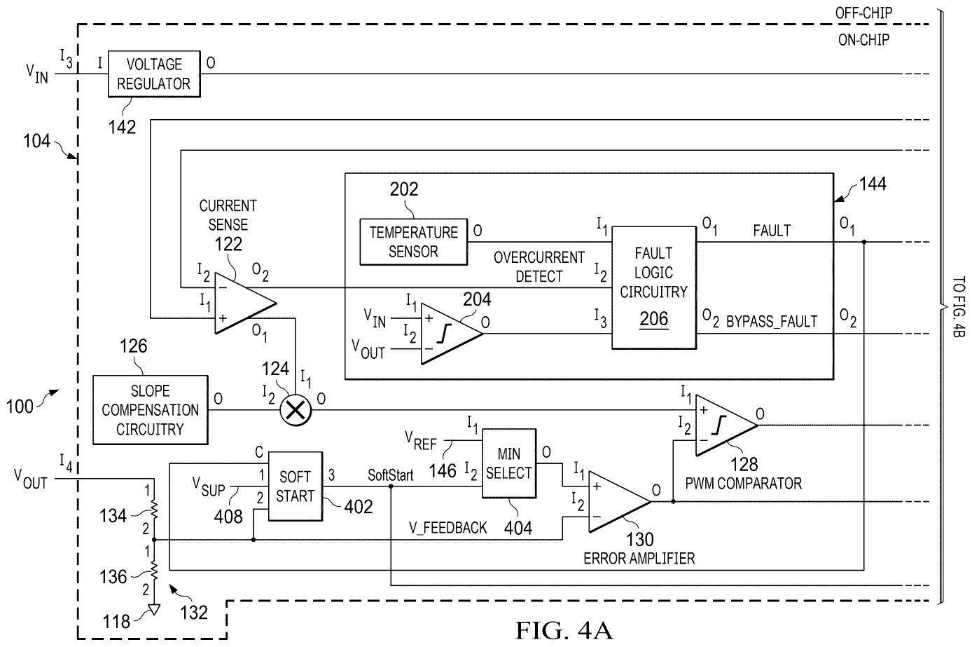

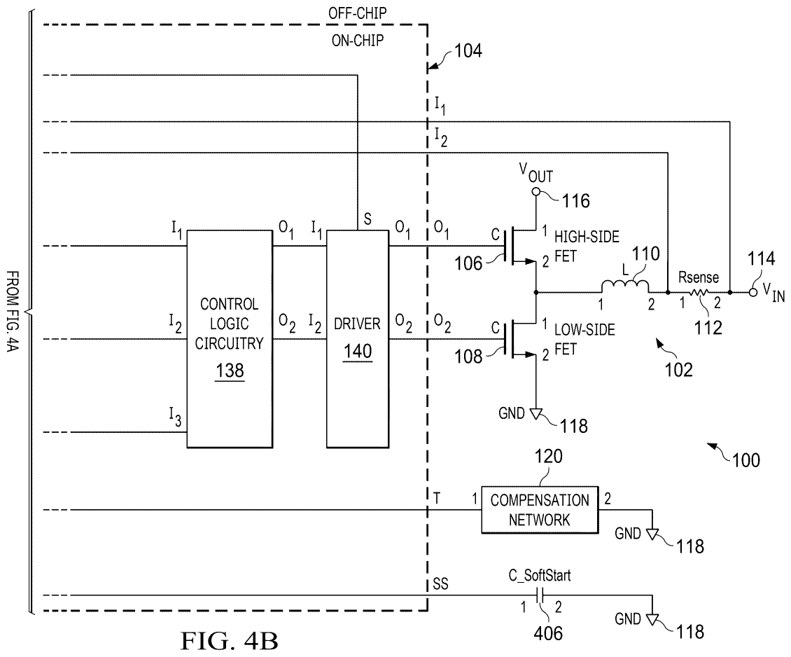

FIG. 4 is a block diagram of the power converter 100 of FIG. 1 where the controller 104 includes the fault controller circuitry 144 of FIG. 2, an example soft start switch 402, and example selection circuitry 404. In the example of FIG. 4, the power converter 100 also includes an example capacitor 406. Also, in the example of FIG. 4, the soft start switch 402 has a control terminal, a first terminal, a second terminal, and a third terminal. The example selection circuitry 404 of FIG. 4 has a first input, a second input, and an output. In the example of FIG. 4, the capacitor 406 has a first terminal and a second terminal.

In the illustrated example of FIG. 4, the control terminal of the soft start switch 402 is coupled to the first output of the fault logic circuitry 206. In the example of FIG. 4, the first terminal of the soft start switch 402 is coupled to an example supply voltage terminal 408. For example, the soft start switch 402 receives a supply voltage (V_{SUP}) at the first terminal. As such, the first terminal of the soft start switch 402 is referred to as a supply input in some examples. In the example of FIG. 4, the supply voltage terminal 408 is the output of the voltage regulator 142. In additional or alternative examples, the first terminal of the soft start switch 402 receives another voltage at another terminal.

In the illustrated example of FIG. 4, the second terminal of the soft start switch 402 is coupled to the second terminal of the resistor 134, the first terminal of the resistor 136, and the second input of the amplifier 130. For example, the soft start switch 402 is coupled to the feedback input of the amplifier 130 and receives the feedback voltage (V_{Feedback}). In the example of FIG. 4, the third terminal of the soft start switch 402 is coupled to the second input of the selection circuitry 404 and the first terminal of the capacitor 406. For example, the connection between the third terminal of the soft start switch 402 and the second input of the selection circuitry 404 corresponds to a soft start terminal (SS) of the controller 104, which, in examples described herein, is also referred to a soft start pin of the controller 104.

In the illustrated example of FIG. 4, the first input of the selection circuitry 404 is coupled to the reference voltage terminal 146. For example, the selection circuitry 404 receives the reference voltage (V_{REF}) at the first input. As such, the first input of the selection circuitry 404 is referred to as a reference input in some examples. In the example of FIG. 4, the second input of the selection circuitry 404 is coupled to the third terminal of the soft start switch 402 and the first terminal of the capacitor 406. As such, the second input of the selection circuitry 404 is referred to as a soft start input in some examples.

In the illustrated example of FIG. 4, the output of the selection circuitry 404 is coupled to the first input of the amplifier 130. In some examples, the output of the selection circuitry 404 is referred to as a selection output. In the example of FIG. 4, the first terminal of the capacitor 406 is coupled to the third terminal of the soft start switch 402. The first terminal of the capacitor 406 is also coupled to the second input of the selection circuitry 404. In the example of FIG. 4, the second terminal of the capacitor 406 is coupled to the reference voltage terminal 118.

In the illustrated example of FIG. 4, when a fault manifests in the power converter 100, a sensor monitoring for the fault (the temperature sensor 202, the amplifier 122, etc.) provides a sensor signal to the fault logic circuitry 206. In the example of FIG. 4, responsive to a sensor signal, the fault logic circuitry 206 provides a fault signal to the control logic circuitry 138. For example, responsive to an asserted sensor signal, the fault logic circuitry 206 asserts the fault signal and provides the fault signal to the control logic circuitry 138 and the soft start switch 402. Responsive to the fault signal, the control logic circuitry 138 provides a first control signal to the driver 140. For example, responsive to an asserted fault signal, the control logic circuitry 138 de-asserts the first control signal. Responsive to the first control signal, the driver 140 disables the high-side FET 106 and the low-side FET 108.

In the illustrated example of FIG. 4, the soft start switch 402 is implemented by a semiconductor device including one or more transistors. For example, the soft start switch 402 is implemented by a single pole, double throw (SPDT) switch that toggles the third terminal of the soft start switch 402 between the supply voltage (V_{SUP}) at the first terminal of the soft start switch 402 and the feedback voltage (V_{Feedback}) at the second terminal of the soft start switch 402. In some examples, the soft start switch 402 is referred to as logic circuitry or switch logic circuitry. As described above, the soft start switch 402 receives the fault signal at the control terminal of the soft start switch 402. When the fault signal is de-asserted, the soft start switch 402 couples the second input of the selection circuitry 404 to the supply voltage (V_{SUP}). For example, when the fault signal is de-asserted, the soft start switch 402 couples the second input of the selection circuitry 404 to the supply voltage terminal 408.

In the illustrated example of FIG. 4, responsive to an asserted fault signal, the soft start switch 402 is toggled and couples the second input of the selection circuitry 404 to the feedback voltage (V_{Feedback}). For example, responsive to the asserted fault signal, the soft start switch 402 couples the second input of the selection circuitry 404 to the second terminal of the resistor 134, the first terminal of the resistor 136, and the second input of the amplifier 130. As such, the soft start switch 402 couples the soft start input of the selection circuitry 404 to the feedback input of the amplifier 130. Thus, when the fault signal is asserted, the soft start switch 402 provides the feedback voltage (V_{Feedback}) to the second input of the selection circuitry 404 and the first terminal of the capacitor 406.

In the illustrated example of FIG. 4, the selection circuitry 404 is implemented by programmable circuitry as described herein. In some examples, the selection circuitry 404 is referred to as logic circuitry or selection logic circuitry. As described above, the selection circuitry 404 receives the reference voltage (V_{REF}) at the reference voltage terminal 146 and the voltage at the third terminal of the soft start switch 402. In the example of FIG. 4, the selection circuitry 404 provides, to the reference input of the amplifier 130, a lower one of the reference voltage (V_{REF}) and the voltage at the second input of the selection circuitry 404. As described above, when the fault signal is de-asserted, the soft start switch 402 provides the supply voltage (V_{SUP}) to the second input of the selection circuitry 404 and the first terminal of the capacitor 406. Also, the supply voltage (V_{SUP}) is greater than the reference voltage (V_{REF}). Thus, the selection circuitry 404 provides the reference voltage (V_{REF}) to the reference input of the amplifier 130 when the fault signal is de-asserted.

As described above, when the fault signal is asserted, the soft start switch 402 provides the feedback voltage (V_{Feedback}) to the second input of the selection circuitry 404 and the first terminal of the capacitor 406. In the example of FIG. 4, the feedback voltage (V_{Feedback}) is less than the supply voltage (V_{SUP}) during a fault condition. As such, when the fault signal is asserted, the capacitor 406 discharges from the supply voltage (V_{SUP}) to the feedback voltage (V_{Feedback}). Also, during a fault condition, the feedback voltage (V_{Feedback}) is less than the reference voltage (V_{REF}). Thus, when the fault signal is asserted, the selection circuitry 404 provides the feedback voltage (V_{Feedback}) to the reference input of the amplifier 130 after the capacitor 406 discharges to the feedback voltage (V_{Feedback}).

In the illustrated example of FIG. 4, the amplifier 204 compares the input voltage (V_{IN}) to the power converter 100 to the output voltage (V_{OUT}) from the power converter 100. In the example of FIG. 4, if the input voltage (V_{IN}) is greater than or equal to the output voltage (V_{OUT}), the amplifier 204 asserts the transistor protection signal. In other words, if the output voltage (V_{OUT}) is less than or equal to the input voltage (V_{IN}), the amplifier 204 asserts the transistor protection signal. Otherwise, if the input voltage (V_{IN}) is less than the output voltage (V_{OUT}), the amplifier 204 de-asserts the transistor protection signal. In other words, if the output voltage (V_{OUT}) is greater than the input voltage (V_{IN}), the amplifier 204 de-asserts the transistor protection signal.

In the illustrated example of FIG. 4, responsive to the transistor protection signal, the fault logic circuitry 206 provides a fault bypass signal to the control logic circuitry 138. For example, responsive to an asserted transistor protection signal, the fault logic circuitry 206 asserts the fault bypass signal and provides the fault bypass signal to the control logic circuitry 138. Responsive to the fault bypass signal, the control logic circuitry 138 provides a second control signal to the driver 140. For example, responsive to an asserted fault bypass signal, the control logic circuitry 138 asserts the second control signal. Responsive to the second control signal, the driver 140 enables the high-side FET 106 in the forward direction.

When a fault is present (during a fault condition) and the high-side FET 106 is enabled (the fault bypass signal is asserted), the output voltage (V_{OUT}) from the power converter 100 is approximately equal to the input voltage (V_{IN}) to the power converter 100. Thus, during a fault condition, the feedback voltage (V_{Feedback}) is based on the input voltage (V_{IN}) to the power converter 100 when the high-side FET 106 is enabled. As such, during a fault condition, the second input of the selection circuitry 404 and the first terminal of the capacitor 406 receive a stepped-down version of the input voltage (V_{IN}) when the high-side FET 106 is enabled. Accordingly, during a fault condition, the capacitor 406 charges to the stepped-down version of the input voltage (V_{IN}) when the high-side FET 106 is enabled.

In the illustrated example of FIG. 4, responsive to a fault clearing, a sensor monitoring the fault de-asserts a sensor signal provided to the fault logic circuitry 206. Responsive to a de-asserted sensor signal, the fault logic circuitry 206 de-asserts the fault signal and the fault bypass signal. In the example of FIG. 4, responsive to the de-asserted fault signal and the de-asserted fault bypass signal, the control logic circuitry 138 de-asserts the second control signal to the driver 140. Responsive to the de-asserted second control signal, the driver 140 disables the high-side FET 106. As such, the power converter 100 can return to normal operation as dictated by the feedback loop and PWM control implemented by the controller 104.

In the illustrated example of FIG. 4, responsive to a de-asserted fault signal, the soft start switch 402 is toggled and couples the second input of the selection circuitry 404 to the supply voltage (V_{SUP}). As described above, when a fault is present (during a fault condition), the capacitor 406 charges to the feedback voltage (V_{Feedback}), which is the stepped-down version of the input voltage (V_{IN}) when the high-side FET 106 is enabled (the fault bypass signal is asserted). As the feedback voltage (V_{Feedback}) is less than the supply voltage (V_{SUP}), the capacitor 406 charges up to the supply voltage (V_{SUP}) when the fault condition clears.

In the illustrated example of FIG. 4, the selection circuitry 404 receives the reference voltage (V_{REF}) at the reference voltage terminal 146 and the voltage at the third terminal of the soft start switch 402, which, when a fault condition clears, is the voltage across the capacitor 406 (V_{SoftStart}). As described above, the selection circuitry 404 provides, to the reference input of the amplifier 130, a lower one of the voltages at the first input and the second input of the selection circuitry 404. Thus, the selection circuitry 404 provides the voltage across the capacitor 406 (V_{SoftStart}) to the reference input of the amplifier 130 until the voltage across the capacitor 406 (V_{SoftStart}) is greater than the reference voltage (V_{REF}). In the example of FIG. 4, the capacitance of the capacitor 406 and an internal current source of the selection circuitry 404 set the slew rate of the voltage across the capacitor 406 (V_{SoftStart}).

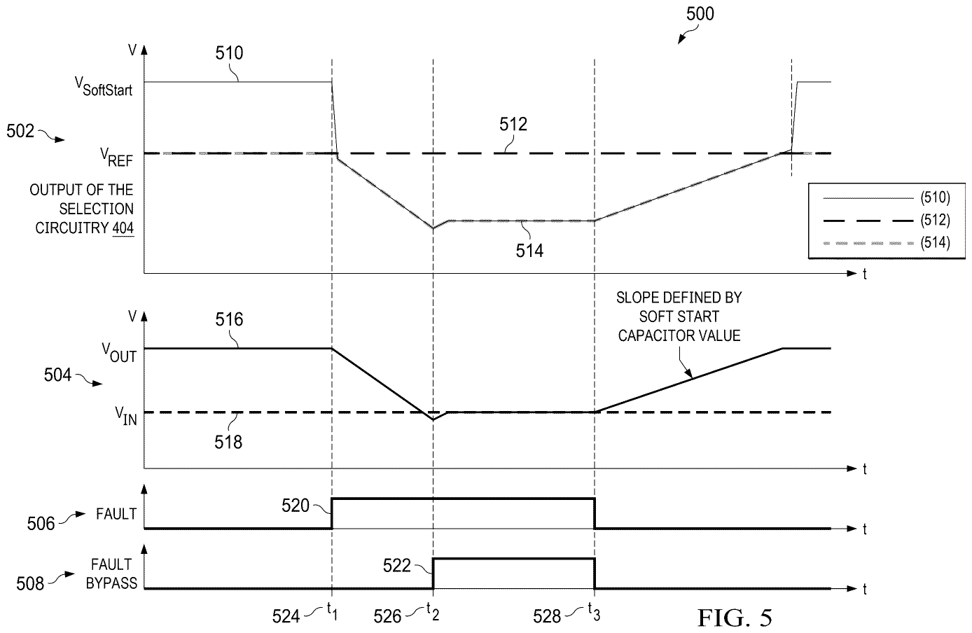

FIG. 5 is an example timing diagram 500 depicting how the controller 104 of FIG. 4 controls a fault response. In the example of FIG. 5, the timing diagram 500 includes a first example graph 502, a second example graph 504, a third example graph 506, and a fourth example graph 508. The graph 502 depicts a first example plot 510 of the voltage across the capacitor 406 (V_{SoftStart}), a second example plot 512 of the reference voltage (V_{REF}), and a third example plot 514 of the signal at the output of the selection circuitry 404 in volts versus time.

In the illustrated example of FIG. 5, the graph 504 depicts a fourth example plot 516 of the output voltage (V_{OUT}) from the power converter 100 and a fifth example plot 518 of the input voltage (V_{IN}) to the power converter 100 in volts versus time. In the example of FIG. 5, the graph 506 depicts a sixth example plot 520 of the fault signal provided by the fault logic circuitry 206 as a binary signal versus time. Also, the graph 508 depicts a seventh example plot 522 of the fault bypass signal provided by the fault logic circuitry 206 as a binary signal versus time.

In the illustrated example of FIG. 5, before a first example time 524 (t₁), the soft start switch 402 provides the supply voltage (V_{SUP}) to the second input of the selection circuitry 404. As such, before the time 524 (t₁), the capacitor 406 charges to the supply voltage (V_{SUP}), which is greater than the reference voltage (V_{REF}) at the reference voltage terminal 146. Thus, the selection circuitry 404 provides the reference voltage (V_{REF}) at the output of the selection circuitry 404 before the time 524 (t₁). Also, before the time 524 (t₁), the controller 104 is in a normal state of operation. For example, before the time 524 (t₁), the controller 104 regulates the high-side FET 106 and the low-side FET 108 to step-up the input voltage (V_{IN}) to a target output voltage (V_{OUT}) based on the voltage at the first input of the amplifier 130, which is the reference voltage (V_{REF}) as described above.

In the illustrated example of FIG. 5, at the time 524 (t₁), the controller 104 detects a fault and disables the high-side FET 106 and the low-side FET 108. For example, if the temperature sensor 202 detects that the temperature of the power converter 100 exceeds the temperature threshold, the temperature sensor 202 asserts a sensor signal. Responsive to the asserted sensor signal, the fault logic circuitry 206 asserts the fault signal (the plot 520) which causes the controller 104 to disable the high-side FET 106 and the low-side FET 108. For example, responsive to the asserted fault signal, the control logic circuitry 138 de-asserts a first control signal. Responsive to the de-asserted first control signal, the driver 140 disables the high-side FET 106 and the low-side FET 108. As such, after the time 524 (t₁), the output voltage (V_{OUT}) from the power converter 100 (the plot 516) begins to decrease.

Also, after the time 524 (t₁), the soft start switch 402 couples the second input of the selection circuitry 404 to the second terminal of the resistor 134, the first terminal of the resistor 136, and the second input of the amplifier 130. For example, responsive to the asserted fault signal, the soft start switch 402 couples the second input of the selection circuitry 404 to the second terminal of the resistor 134, the first terminal of the resistor 136, and the second input of the amplifier 130. As such, when the fault signal is asserted, the soft start switch 402 provides the feedback voltage (V_{Feedback}) to the second input of the selection circuitry 404 and the first terminal of the capacitor 406. Thus, after the time 524 (t₁), the capacitor 406 discharges from the supply voltage (V_{SUP}) to the feedback voltage (V_{Feedback}). Once the voltage across the capacitor 406 (V_{SoftStart}) meets the reference voltage (V_{REF}), the ramp at which the capacitor 406 discharges to the feedback voltage (V_{Feedback}) is based on the rate at which the output voltage (V_{OUT}) (the plot 516) discharges. In some examples, the ramp at which the capacitor 406 discharges to the feedback voltage (V_{Feedback}) is based on the capacitance of the capacitor 406 and an internal current source of the selection circuitry 404.

As described above, the amplifier 204 continues to monitor the output voltage (V_{OUT}) (the plot 516) and the input voltage (V_{IN}) (the plot 518). At a second example time 526 (t₂), the controller 104 detects that the output voltage (V_{OUT}) is less than the input voltage (V_{IN}) and enables the high-side FET 106. For example, if the amplifier 204 detects that the output voltage (V_{OUT}) is less than the input voltage (V_{IN}), the amplifier 204 asserts a transistor protection signal. Responsive to the asserted transistor protection signal, the fault logic circuitry 206 asserts the fault bypass signal (the plot 522) which causes the controller 104 to enable the high-side FET 106. For example, responsive to the asserted fault bypass signal, the control logic circuitry 138 asserts a second control signal. Responsive to the asserted second control signal, the driver 140 enables the high-side FET 106.

As such, after the time 526 (t₂), the high-side FET 106 is enabled, and the output voltage (V_{OUT}) (the plot 516) is approximately equal to the input voltage (V_{IN}) (the plot 518). As such, the controller 104 ensures that the voltage drop across the high-side FET 106 is defined by the “on” resistance of the high-side FET 106 and thus, far lower than the reverse bias voltage drop across the high-side FET 106. For example, if the “on” resistance of the high-side FET 106 is five milliohms (R_{DS}=5 mΩ) and the load current is 10 A (I_{LOAD}=10 A), then the power dissipated by the high-side FET 106 is 500 milliwatts (P=R_{DS}*I_{LOAD}=500 mW) which is much less than the 20 Watts that the high-side FET 106 would dissipate if reverse biased.

In the illustrated example of FIG. 5, at a third example time 528 (t₃), the controller 104 detects that the fault has cleared. For example, the temperature sensor 202 detects that the temperature of the power converter 100 is less than the temperature threshold and de-asserts the sensor signal. Responsive to the de-asserted sensor signal, the fault logic circuitry 206 de-asserts the fault signal (the plot 520) and the fault bypass signal (the plot 522). Responsive to the de-asserted fault signal and the de-asserted fault bypass signal, the control logic circuitry 138 de-asserts the second control signal. Responsive to the de-asserted second control signal, the driver 140 disables the high-side FET 106.

In the illustrated example of FIG. 5, after the time 528 (t₃), the soft start switch 402 couples the second input of the selection circuitry 404 to the supply voltage terminal 408. For example, responsive to the de-asserted fault signal, the soft start switch 402 couples the second input of the selection circuitry 404 to the supply voltage terminal 408. As such, when the fault signal is de-asserted, the soft start switch 402 provides the supply voltage (V_{SUP}) to the second input of the selection circuitry 404 and the first terminal of the capacitor 406. Thus, after the time 528 (t₃), the capacitor 406 charges from the feedback voltage (V_{Feedback}) to the supply voltage (V_{SUP}). Once the voltage across the capacitor 406 (V_{SoftStart}) meets the reference voltage (V_{REF}), the ramp at which the capacitor 406 charges to the supply voltage (V_{SUP}) is based on the capacitance of the capacitor 406 and an internal current source of the selection circuitry 404.

In the illustrated example of FIG. 5, the controller 104 can return to normal operation after the time 528 (t₃). For example, after the time 528 (t₃), the controller 104 regulates the high-side FET 106 and the low-side FET 108 to step-up the input voltage (V_{IN}) to a target output voltage (V_{OUT}) based on the voltage at the first input of the amplifier 130. As described above, the voltage at the first input of the amplifier 130 is the lesser of the voltages at first input and the second input of the selection circuitry 404. In the example of FIG. 5, after the time 528 (t₃), the capacitor 406 charges from the feedback voltage (V_{Feedback}) to the supply voltage (V_{SUP}). As described above, the rate at which the capacitor 306 charges is based on the capacitance of the capacitor 406 and an internal current source of the selection circuitry 404. Thus, the slew rate at which the power converter 100 steps up to the target output voltage (V_{OUT}) is based on the capacitance of the capacitor 406. Once the voltage across the capacitor 406 (V_{SoftStart}) is greater than the reference voltage (V_{REF}), the selection circuitry 404 provides the reference voltage (V_{REF}) at the output of the selection circuitry 404.

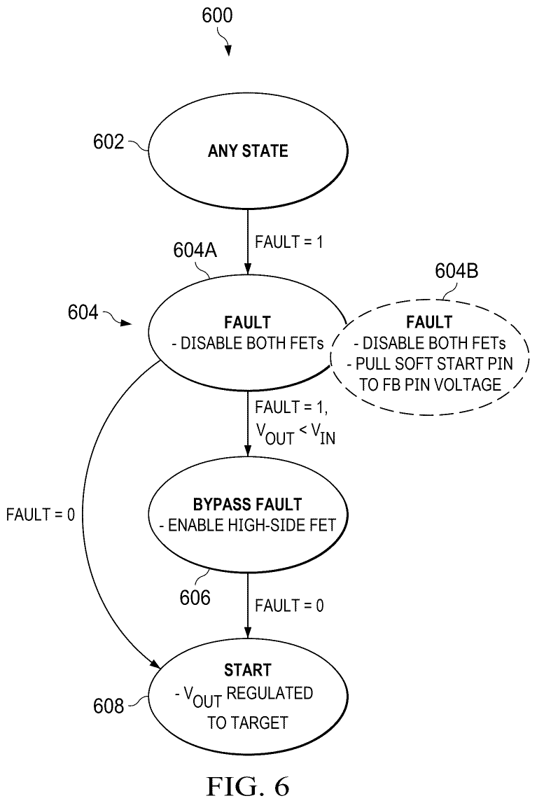

FIG. 6 is an example state diagram 600 depicting example states of operation of the controller 104 of FIG. 2 or 4. In the example of FIG. 6, the state diagram 600 includes a first example state 602, a second example state 604, a third example state 606, and a fourth example state 608. Also, the state 604 includes a first example sub-state 604A corresponding to the controller 104 of FIG. 2 and a second example sub-state 604B corresponding to the controller 104 of FIG. 4. In the example of FIG. 6, the state diagram 600 begins at the state 602 which is representative of any state of operation of the controller 104. For example, the state 602 represents normal operation (non-fault operation) of the controller 104.

In the illustrated example of FIG. 6, in the state 602, the controller 104 regulates the high-side FET 106 and the low-side FET 108 to step-up the input voltage (V_{IN}) to a target output voltage (V_{OUT}) based on the reference voltage (V_{REF}) at the reference voltage terminal 146. In the example of FIG. 6, the controller 104 transitions from the state 602 to the state 604 when a fault manifests. For example, responsive to an asserted sensor signal (from the temperature sensor 202, from the amplifier 122, etc.), the fault logic circuitry 206 asserts the fault signal. Responsive to the asserted fault signal, the controller 104 transitions to the state 604.

In the illustrated example of FIG. 6, the state 604 is a fault state in which the controller 104 stops regulating the high-side FET 106 and the low-side FET 108. In the sub-state 604A, the controller 104 disables the high-side FET 106 and the low-side FET 108. For example, responsive to the asserted fault signal from the fault logic circuitry 206, the control logic circuitry 138 de-asserts a first control signal and provides the first control signal to the driver 140. Responsive to the de-asserted first control signal, the driver 140 disables the high-side FET 106 and the low-side FET 108.

In the illustrated example of FIG. 6, in addition to disabling the high-side FET 106 and the low-side FET 108, the controller 104 also pulls the soft start pin of the controller 104 to the voltage at the feedback pin of the controller 104 in the sub-state 604B. For example, responsive to the asserted fault signal, the soft start switch 402 couples the second input of the selection circuitry 404 and the first terminal of the capacitor 406 to the second terminal of the resistor 134, the first terminal of the resistor 136, and the second input of the amplifier 130. Depending on the conditions of the power converter 100, the controller 104 transitions from the state 604 to the state 606 or to the state 608.

For example, the controller 104 transitions from the state 604 to the state 608 when the fault clears. In the example of FIG. 6, responsive to a de-asserted sensor signal (from the temperature sensor 202, from the amplifier 122, etc.), the fault logic circuitry 206 de-asserts the fault signal. Responsive to the de-asserted fault signal, the controller 104 transitions to the state 608. In the example of FIG. 6, the controller 104 transitions from the state 604 to the state 606 when the output voltage (V_{OUT}) from the power converter 100 falls below the input voltage (V_{IN}) to the power converter 100 while a fault is present. For example, while a fault is present (the fault signal is asserted), the fault logic circuitry 206 asserts the fault bypass signal responsive to an asserted transistor protection signal from the amplifier 204 (indicating that the output voltage is less than the input voltage). Responsive to the asserted fault bypass signal, the controller 104 transitions to the state 606.

In the illustrated example of FIG. 6, the state 606 is a fault bypass state in which the controller 104 enables the high-side FET 106 in the forward direction to prevent the high-side FET 106 from being damaged. For example, responsive to the asserted fault bypass signal from the fault logic circuitry 206, the control logic circuitry 138 asserts a second control signal and provides the second control signal to the driver 140. Responsive to the asserted second control signal, the driver 140 enables the high-side FET 106 in the forward direction. As such, the high-side FET 106 is not reverse biased even though the output voltage (V_{OUT}) from the power converter 100 was less than the input voltage (V_{IN}) to the power converter 100. Thus, the high-side FET 106 does not dissipate power to a level that could damage the high-side FET 106.

In the illustrated example of FIG. 6, the controller 104 transitions from the state 606 to the state 608 when the fault clears. For example, responsive to a de-asserted sensor signal (from the temperature sensor 202, from the amplifier 122, etc.) while in the state 606, the fault logic circuitry 206 de-asserts the fault signal. Responsive to the de-asserted fault signal from the fault logic circuitry 206, the control logic circuitry 138 de-asserts the second control signal and provides the second control signal to the driver 140. Responsive to the de-asserted second control signal, the driver 140 disables the high-side FET 106 and the controller 104 returns to normal control of the high-side FET 106 and the low-side FET 108. For example, the amplifier 128 compares the slope compensated sensed current signal provided by the mixer 124 to the error signal provided by the amplifier 130.

Based on the comparison, the amplifier 128 generates a PWM signal and provides the PWM signal to the control logic circuitry 138. Responsive to the PWM signal, the control logic circuitry 138 provides a control signal to the driver 140. Responsive to the control signal, the driver 140 controls one or more of the high-side FET 106 or the low-side FET 108. As such, the controller 104 regulates the high-side FET 106 and the low-side FET 108 to step up the input voltage (V_{IN}) to a target output voltage (V_{OUT}) based on the voltage at the first input of the amplifier 130. As described above, in the controller 104 of FIG. 2, the voltage at the first input of the amplifier 130 is the reference voltage (V_{REF}) and in the controller 104 of FIG. 4, the voltage at the first input of the amplifier 130 varies depending on which of the voltage across the capacitor 406 (V_{SoftStart}) and the reference voltage (V_{REF}) is larger.

For example, the selection circuitry 404 switches the voltage at the first input of the amplifier 130 from the voltage across the capacitor 406 (V_{SoftStart}) to the reference voltage (V_{REF}) when the voltage across the capacitor 406 (V_{SoftStart}) exceeds the reference voltage (V_{REF}). As described above, the rate at which the capacitor 406 charges from the feedback voltage (V_{Feedback}) to the supply voltage (V_{SUP}) is based on the capacitance of the capacitor 406 and an internal current source of the selection circuitry 404 until the voltage across the capacitor 406 (V_{SoftStart}) meets the reference voltage (V_{REF}). Thus, the slew rate at which the power converter 100 steps up to the target output voltage (V_{OUT}) is based on the capacitance of the capacitor 406.

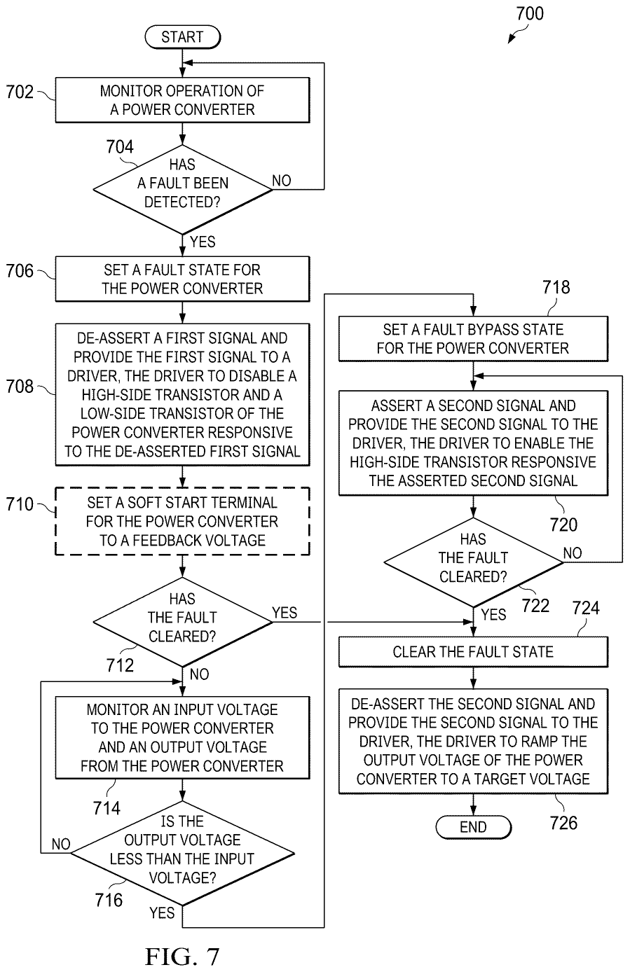

FIG. 7 is a flowchart representative of at least one of example machine-readable instructions or example operations 700 that may be at least one of executed, instantiated, or performed by programmable circuitry to implement the controller 104 of FIG. 2 or 4. The at least one of the example machine-readable instructions or the example operations 700 of FIG. 7 begin at block 702, at which the fault logic circuitry 206 monitors operation of a power converter. For example, the fault logic circuitry 206 monitors operation of the power converter 100 via one or more sensors such as the temperature sensor 202 and the amplifier 122. At block 704, the fault logic circuitry 206 determines whether a fault has been detected. For example, the fault logic circuitry 206 determines whether an asserted sensor signal has been received indicating that a fault has manifested.

In the illustrated example of FIG. 7, responsive to the fault logic circuitry 206 determining that a fault has not been detected (block 704: NO), the at least one of the machine-readable instructions or the operations 700 return to block 702. Responsive to the fault logic circuitry 206 determining that a fault has been detected (block 704: YES), the at least one of the machine-readable instructions or the operations 700 proceed to block 706. At block 706, the fault logic circuitry 206 sets a fault state for the power converter. For example, the fault logic circuitry 206 asserts the fault signal. At block 708, responsive to the set fault state, the control logic circuitry 138 de-asserts a first control signal and provides the first control signal to a driver. Responsive to the de-asserted first control signal, the driver disables a high-side transistor and a low-side transistor of the power converter.

In some examples, the at least one of the machine-readable instructions or the operations 700 include block 710. For example, when the at least one of the machine-readable instructions or the operations 700 are utilized to implement the controller 104 of FIG. 4, the at least one of the machine-readable instructions or the operations 700 include block 710. At block 710, responsive to the set fault state, the soft start switch 402 sets a soft start terminal for the power converter to a feedback voltage. For example, responsive to the asserted fault signal, the soft start switch 402 couples the soft start input of the selection circuitry 404 to the feedback input of the amplifier 130, which receives the feedback voltage (V_{Feedback}).

In the illustrated example of FIG. 7, at block 712, the fault logic circuitry 206 determines if the fault has cleared. For example, the fault logic circuitry 206 determines whether an asserted sensor signal is still present. Responsive to the fault logic circuitry 206 determining that the fault has cleared (block 712: YES), the at least one of the machine-readable instructions or the operations 700 proceed to block 724. Responsive to the fault logic circuitry 206 determining that the fault has not cleared (block 712: NO), the at least one of the machine-readable instructions or the operations 700 proceed to block 714. At block 714, the amplifier 204 monitors an input voltage to the power converter and an output voltage from the power converter.

In the illustrated example of FIG. 7, at block 716, the amplifier 204 determines whether the output voltage is less than the input voltage. If the amplifier 204 determines that the output voltage is less than the input voltage, the amplifier 204 asserts a transistor protection signal. Responsive to the amplifier 204 determining that the output voltage is not less than the input voltage (block 716: NO), the at least one of the machine-readable instructions or the operations 700 return to block 714. Responsive to the amplifier 204 determining that the output voltage is less than the input voltage (block 716: YES), the at least one of the machine-readable instructions or the operations 700 proceed to block 718. At block 718, responsive to the asserted transistor protection signal, the fault logic circuitry 206 sets a fault bypass state for the power converter. For example, the fault logic circuitry 206 asserts the fault bypass signal.

In the illustrated example of FIG. 7, responsive to the set fault bypass state, the control logic circuitry 138 asserts a second control signal and provides the second control signal to the driver at block 720. Responsive to the asserted second control signal, the driver enables the high-side transistor. As such, the high-side transistor will not be reverse biased and is protected from dissipating power to a level that could damage the high-side transistor. In the example of FIG. 7, at block 722, the fault logic circuitry 206 determines if the fault has cleared. For example, the fault logic circuitry 206 determines whether an asserted sensor signal is still present. Responsive to the fault logic circuitry 206 determining that the fault has not cleared (block 722: NO), the at least one of the machine-readable instructions or the operations 700 return to block 720.

In the illustrated example of FIG. 7, responsive to the fault logic circuitry 206 determining that the fault has cleared (block 722: YES), the at least one of the machine-readable instructions or the operations 700 proceed to block 724. At block 724, the fault logic circuitry 206 clears the fault state. For example, the fault logic circuitry 206 de-asserts the fault signal. At block 726, responsive to the cleared fault state, the control logic circuitry 138 de-asserts the second control signal and provides the second control signal to the driver. Responsive to the de-asserted second control signal, the driver disables the high-side transistor, and the power converter returns to normal operation. For example, the driver ramps the output voltage of the power converter to a target voltage.

As described above, when the at least one of the machine-readable instructions or the operations 700 are utilized to implement the controller 104 of FIG. 4, the soft start switch 402 sets the soft start terminal for the power converter to the feedback voltage responsive to a set fault state. For example, responsive to a set fault state, the soft start switch 402 couples the soft start input of the selection circuitry 404 to the feedback input of the amplifier 130, which receives the feedback voltage. Likewise, responsive to a cleared fault state, the soft start switch 402 decouples the soft start input of the selection circuitry 404 from the feedback input of the amplifier 130 and couples the soft start input to the supply voltage terminal 408. Thus, the capacitor 406 charges to the supply voltage (V_{SUP}). As described above, the slew rate at which the power converter 100 steps up to the target output voltage (V_{OUT}) is based on the capacitance of the capacitor 406 when the at least one of the machine-readable instructions or the operations 700 are utilized to implement the controller 104 of FIG. 4.

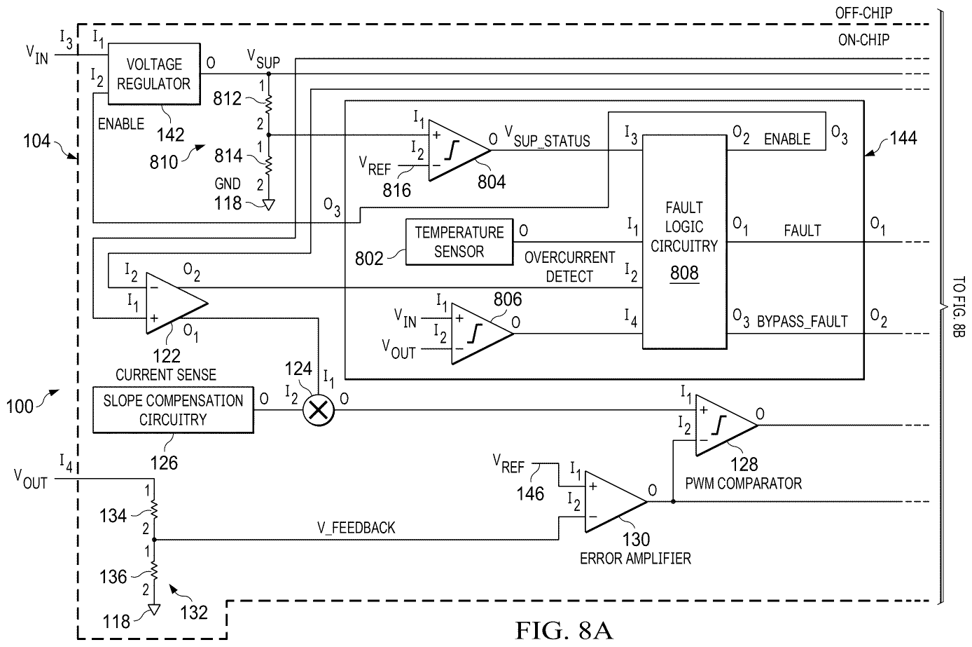

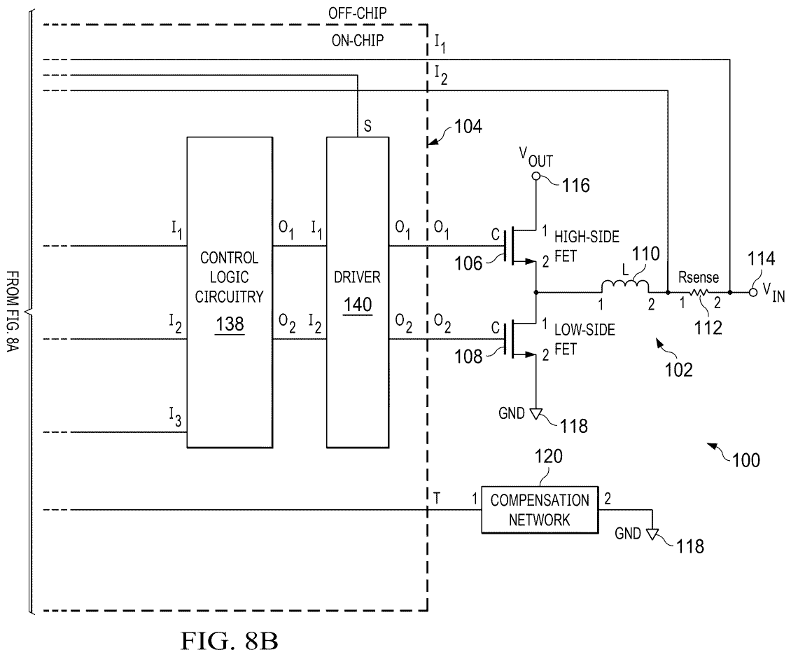

FIG. 8 is a block diagram of the power converter 100 of FIG. 1 depicting a second example implementation of the fault controller circuitry 144 of FIG. 1. The example fault controller circuitry 144 of FIG. 8 includes an example temperature sensor 802, a first example amplifier 804, a second example amplifier 806, and example fault logic circuitry 808. In the example of FIG. 8, the controller 104 also includes an example voltage divider 810 including a first example resistor 812 and a second example resistor 814.

In the illustrated example of FIG. 8, the temperature sensor 802 has an output and each of the amplifier 804 and the amplifier 806 has a first input, a second input, and an output. In the example of FIG. 8, the fault logic circuitry 808 has a first input, a second input, a third input, a fourth input, a first output, a second output, and a third output. In the example of FIG. 8, each of the resistor 812 and the resistor 814 has a first terminal and a second terminal. Also, in the example of FIG. 8, the amplifier 122 has a first output and a second output and the voltage regulator 142 has a first input and a second input. For example, the first output of the amplifier 122 is coupled to the first input of the mixer 124 and the first input of the voltage regulator 142 receives the input voltage (V_{IN}) at the input voltage terminal 114.

In the illustrated example of FIG. 8, the output of the temperature sensor 802 is coupled to the first input of the fault logic circuitry 808. Also, the second output of the amplifier 122 is coupled to the second input of the fault logic circuitry 808. In the example of FIG. 8, the first input of the amplifier 804 is coupled to the second terminal of the resistor 812 and the first terminal of the resistor 814 and the second input of the amplifier 804 is coupled to an example reference voltage terminal 816. Also, the output of the amplifier 804 is coupled to the third input of the fault logic circuitry 808.

In the illustrated example of FIG. 8, the first input of the amplifier 806 is coupled to the input voltage terminal 114 of the power converter 100. For example, the amplifier 806 receives the input voltage (V_{IN}) to the power converter 100 at the first input. In the example of FIG. 8, the second input of the amplifier 806 is coupled to the output voltage terminal 116 of the power converter 100. For example, the amplifier 806 receives the output voltage (V_{OUT}) from the power converter 100 at the second input. In the example of FIG. 8, the output of the amplifier 806 is coupled to the fourth input of the fault logic circuitry 808.

In the illustrated example of FIG. 8, the first input of the fault logic circuitry 808 is coupled to the output of the temperature sensor 802. In the example of FIG. 8, the second input of the fault logic circuitry 808 is coupled to the second output of the amplifier 122. Also, the third input of the fault logic circuitry 808 is coupled to the output of the amplifier 804. In the example of FIG. 8, the fourth input of the fault logic circuitry 808 is coupled to the output of the amplifier 806. Also, the first output of the fault logic circuitry 808 is coupled to the first input of the control logic circuitry 138. In the example of FIG. 8, the second output of the fault logic circuitry 808 is coupled to the second input of the voltage regulator 142 and the third output of the fault logic circuitry 808 is coupled to the second input of the control logic circuitry 138.

In the illustrated example of FIG. 8, the first terminal of the resistor 812 is coupled to the output of the voltage regulator 142. In the example of FIG. 8, the second terminal of the resistor 812 is coupled to the first input of the amplifier 804 and the first terminal of the resistor 814. Also, the first terminal of the resistor 814 is coupled to the first input of the amplifier 804 and the second terminal of the resistor 812. In the example of FIG. 8, the second terminal of the resistor 814 is coupled to the reference voltage terminal 118. In the example of FIG. 8, the voltage divider 810 provides a stepped down version of the supply voltage (V_{SUP}) between the second terminal of the resistor 812 and the first terminal of the resistor 814.

In the illustrated example of FIG. 8, the temperature sensor 802 is implemented similarly to the temperature sensor 202 of FIG. 2. If the temperature of the power converter 100 exceeds a temperature threshold (indicating an overtemperature fault has manifested), the temperature sensor 802 provides a sensor signal to the fault logic circuitry 808. For example, responsive to a fault, the temperature sensor 802 asserts the sensor signal. In the example of FIG. 8, the amplifier 122 is implemented as described above. If the sensed current through the resistor 112 exceeds the current threshold (indicating an overcurrent fault has manifested), the amplifier 122 provides a sensor signal to the fault logic circuitry 808. For example, responsive to a fault, the amplifier 122 asserts the sensor signal. In additional or alternative examples, the controller 104 or the fault logic circuitry 808 includes one or more additional sensors to monitor for one or more additional or alternative faults such as overvoltage faults or undervoltage faults, among others.

In the illustrated example of FIG. 8, the amplifier 804 is implemented by circuitry including one or more op-amps. Also, the first input of the amplifier 804 is a non-inverting input and the second input of the amplifier 804 is an inverting input. In the example of FIG. 8, the amplifier 804 is a supply status comparator that compares a stepped down version of the supply voltage (V_{SUP}) at the first input of the amplifier 804 to the reference voltage (V_{REF}) at the second input of the amplifier 804. As such, the first input and the second input of the amplifier 804 are referred to as a feedback input and a reference input, respectively, in some examples.

In the illustrated example of FIG. 8, the amplifier 804 provides a supply status signal (V_{SUP_STATUS}) to the fault logic circuitry 808 based on the comparison. As such, in some examples, the output of the amplifier 804 is referred to as a control output and the third input of the fault logic circuitry 808 is referred to as a supply status input. In the example of FIG. 8, if the stepped down version of the supply voltage (V_{SUP}) is greater than or equal to the reference voltage (V_{REF}), the amplifier 804 asserts the supply status signal. For example, an asserted supply status signal indicates that the supply voltage (V_{SUP}) is at an expected level. Otherwise, if the stepped down version of the supply voltage (V_{SUP}) is less than the reference voltage (V_{REF}), the amplifier 804 de-asserts the supply status signal. For example, a de-asserted supply status signal indicates that the supply voltage (V_{SUP}) is not at an expected level and that the voltage regulator 142 is experiencing a fault.

As described above, when a fault manifests in the power converter 100, a sensor monitoring for the fault (the temperature sensor 802, the amplifier 122, etc.) provides a sensor signal to the fault logic circuitry 808. In the example of FIG. 8, the fault logic circuitry 808 is implemented by programmable circuitry as described herein. As described above, the first input of the fault logic circuitry 808 is coupled to the output of the temperature sensor 802 and the second input of the fault logic circuitry 808 is coupled to the second output of the amplifier 122. As such, the first input and the second input of the fault logic circuitry 808 are referred to as a first sensor input and a second sensor input, respectively, in some examples.

In the illustrated example of FIG. 8, responsive to a sensor signal, the fault logic circuitry 808 provides a fault signal to the control logic circuitry 138. For example, responsive to an asserted sensor signal, the fault logic circuitry 808 asserts the fault signal and provides the fault signal via the first output of the fault logic circuitry 808. As such, the first output of the fault logic circuitry 808 is referred to as a fault output in some examples. In power converters, distinguishing between a fault associated with an output stage and a fault associated with a controller of the output stage is helpful for the controller to effectively respond to the fault. However, distinguishing between a fault associated with an output stage and a fault associated with a controller of the output stage can be difficult.

For example, an overtemperature fault can be caused by any component of the power converter 100 overheating, not just the high-side FET 106 and the low-side FET 108. Also or alternatively, an overcurrent fault can be caused by the supply voltage (V_{SUP}) to the driver 140 falling below an expected value. Without distinguishing between a fault associated with an output stage and a fault associated with a controller of the output stage, a controller may not be able to properly respond to the fault. Advantageously, the fault controller circuitry 144 includes one or more sensors to monitor additional characteristics of the power converter 100. For example, the fault controller circuitry 144 includes the amplifier 804 to monitor the supply voltage (V_{SUP}). As such, readings from the one or more sensors can be cross-referenced when a fault manifests to determine a causes of the fault.

In the illustrated example of FIG. 8, the amplifier 804 compares the stepped down version of the supply voltage (V_{SUP}) to the reference voltage (V_{REF}) at the reference voltage terminal 816, as described above. As such, the fault logic circuitry 808 can differentiate between a fault associated with the output stage 102 and a fault associated with the voltage regulator 142 utilizing the supply status signal from the amplifier 804. For example, responsive to an asserted sensor signal, the fault logic circuitry 808 asserts the fault signal and checks the supply status signal. Responsive to the supply status signal, the fault logic circuitry 808 provides, to the voltage regulator 142, an enable signal at the second output of the fault logic circuitry 808. As such, the fault controller circuitry 144 of FIG. 8 includes a third output that provides the enable signal to the voltage regulator 142. Also, the second output of the fault logic circuitry 808 is referred to as a supply enable output in some examples.

In the illustrated example of FIG. 8, responsive to an asserted supply status signal (indicating the supply voltage (V_{SUP}) is at an expected level), the fault logic circuitry 808 asserts the enable signal. Responsive to an asserted fault signal and an asserted enable signal, the controller 104 operates similarly to the controller 104 of FIG. 2 to troubleshoot the output stage 102. In the example of FIG. 8, responsive to a de-asserted supply status signal (indicating the supply voltage (V_{SUP}) is not at an expected level), the fault logic circuitry 808 de-asserts the enable signal. Responsive to an asserted fault signal and a de-asserted enable signal, the controller 104 troubleshoots the voltage regulator 142. In this manner, the controller 104 distinguishes between a fault associated with the output stage 102 and a fault associated with the controller 104.

Thus, if a temperature fault manifests while the supply voltage (V_{SUP}) is collapsed, the fault logic circuitry 808 can determine that the cause of the temperature fault is likely the voltage regulator 142 and not high load current. As such, the fault logic circuitry 808 can disable the voltage regulator 142 to troubleshoot the temperature fault as opposed to troubleshooting by disabling the high-side FET 106 and the low-side FET 108. In additional or alternative examples, the fault controller circuitry 144, or, more generally, the controller 104 includes one or more additional or alternative sensors. For example, the one or more additional or alternative sensors monitor one or more additional or alternative voltages or currents to facilitate distinction between a fault associated with the output stage 102 and a fault associated with the controller 104.

In the illustrated example of FIG. 8, as described above, the controller 104 troubleshoots the voltage regulator 142 responsive to an asserted fault signal and a de-asserted enable signal. For example, responsive to an asserted fault signal, the control logic circuitry 138 de-asserts a first control signal and provides the first control signal to the driver 140. Responsive to the de-asserted first control signal, the driver 140 disables the high-side FET 106 and the low-side FET 108. Responsive to a de-asserted enable signal, the voltage regulator 142 disables. For example, responsive to the de-asserted enable signal, the voltage regulator 142 stops providing the supply voltage (V_{SUP}) at the output of the voltage regulator 142.

In the illustrated example of FIG. 8, responsive to a fault clearing, a sensor monitoring the fault de-asserts a sensor signal provided to the fault logic circuitry 808. For example, responsive to an overtemperature fault clearing (the temperature of the power converter 100 falling below the temperature threshold), the temperature sensor 802 de-asserts the sensor signal provided to the fault logic circuitry 808. Also, for example, responsive to an overcurrent fault clearing (the current through the resistor 112 falls below the current threshold), the amplifier 122 de-asserts the sensor signal provided to the fault logic circuitry 808.

In the illustrated example of FIG. 8, responsive to a de-asserted sensor signal, the fault logic circuitry 808 de-asserts the fault signal and asserts the enable signal. In the example of FIG. 8, responsive to the asserted enable signal, the voltage regulator 142 enables. For example, the voltage regulator 142 provides the supply voltage (V_{SUP}) at the output of the voltage regulator 142. In the example of FIG. 8, responsive to the de-asserted fault signal, the control logic circuitry 138 provides a control signal to the driver 140 based on the feedback loop and PWM control implemented by the controller 104. Responsive to the control signal, the driver 140 controls one or more of the high-side FET 106 or the low-side FET 108. As such, the power converter 100 can return to normal operation as dictated by the feedback loop and PWM control implemented by the controller 104.

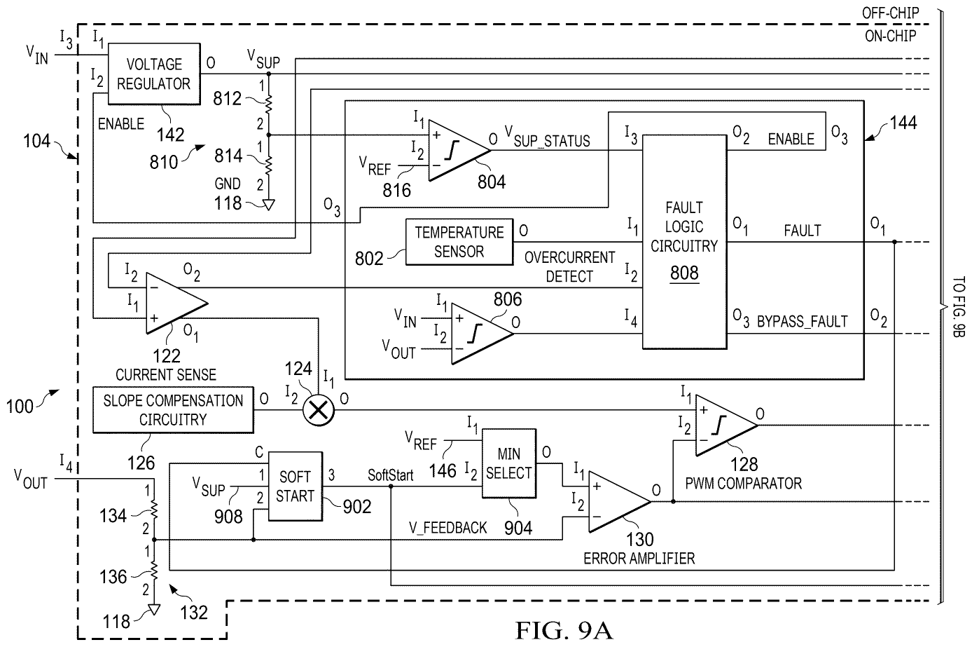

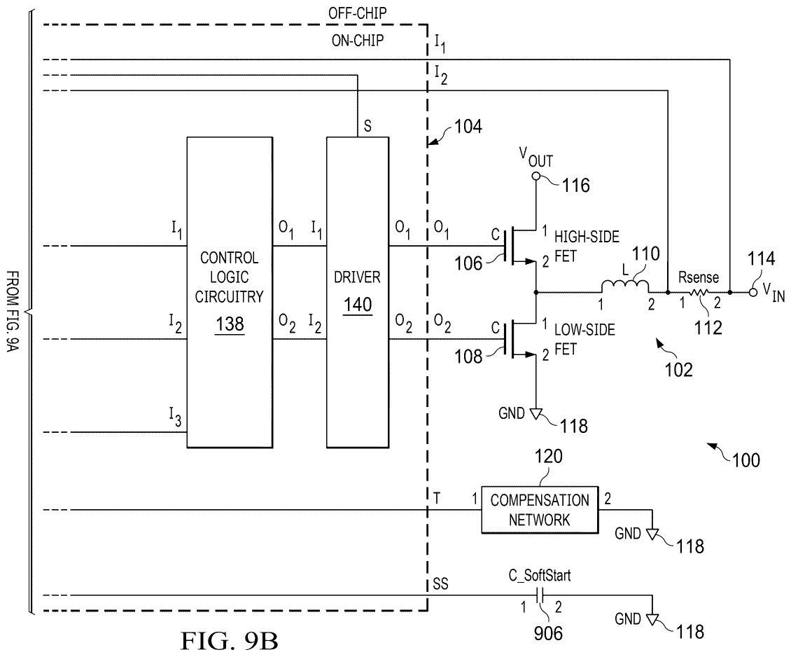

FIG. 9 is a block diagram of the power converter 100 of FIG. 1 where the controller 104 includes the fault controller circuitry 144 of FIG. 8, an example soft start switch 902, and example selection circuitry 904. In the example of FIG. 9, the power converter 100 also includes an example capacitor 906. Also, in the example of FIG. 9, the soft start switch 902 has a control terminal, a first terminal, a second terminal, and a third terminal. The example selection circuitry 904 of FIG. 9 has a first input, a second input, and an output. In the example of FIG. 9, the capacitor 906 has a first terminal and a second terminal.

In the illustrated example of FIG. 9, the control terminal of the soft start switch 902 is coupled to the first output of the fault logic circuitry 808. In the example of FIG. 9, the first terminal of the soft start switch 902 is coupled to an example supply voltage terminal 908. For example, the soft start switch 902 receives a supply voltage (V_{SUP}) at the first terminal. As such, the first terminal of the soft start switch 902 is referred to as a supply input in some examples. In the example of FIG. 9, the supply voltage terminal 908 is the output of the voltage regulator 142. In additional or alternative examples, the first terminal of the soft start switch 902 receives another voltage at another terminal.

In the illustrated example of FIG. 9, the second terminal of the soft start switch 902 is coupled to the second terminal of the resistor 134, the first terminal of the resistor 136, and the second input of the amplifier 130. For example, the soft start switch 902 is coupled to the feedback input of the amplifier 130 and receives the feedback voltage (V_{Feedback}). In the example of FIG. 9, the third terminal of the soft start switch 902 is coupled to the second input of the selection circuitry 904 and the first terminal of the capacitor 906. For example, the connection between the third terminal of the soft start switch 902 and the second input of the selection circuitry 904 corresponds to a soft start terminal of the controller 104, which, in examples described herein, is also referred to a soft start pin of the controller 104.

In the illustrated example of FIG. 9, the first input of the selection circuitry 904 is coupled to the reference voltage terminal 146. For example, the selection circuitry 904 receives the reference voltage (V_{REF}) at the first input. As such, the first input of the selection circuitry 904 is referred to as a reference input in some examples. In the example of FIG. 9, the second input of the selection circuitry 904 is coupled to the third terminal of the soft start switch 902 and the first terminal of the capacitor 906. As such, the second input of the selection circuitry 904 is referred to as a soft start input in some examples.

In the illustrated example of FIG. 9, the output of the selection circuitry 904 is coupled to the first input of the amplifier 130. In some examples, the output of the selection circuitry 904 is referred to as a selection output. In the example of FIG. 9, the first terminal of the capacitor 906 is coupled to the third terminal of the soft start switch 902. The first terminal of the capacitor 906 is also coupled to the second input of the selection circuitry 904. In the example of FIG. 9, the second terminal of the capacitor 906 is coupled to the reference voltage terminal 118.

In the illustrated example of FIG. 9, the soft start switch 902 is implemented similarly to the soft start switch 402 of FIG. 4. For example, the soft start switch 902 is implemented by an SPDT switch that toggles the third terminal of the soft start switch 902 between the supply voltage (V_{SUP}) at the first terminal of the soft start switch 902 and the feedback voltage (V_{Feedback}) at the second terminal of the soft start switch 902. In the example of FIG. 9, the selection circuitry 904 is implemented similarly to the selection circuitry 404 of FIG. 4. Also, the capacitor 906 is implemented similarly to the capacitor 406 of FIG. 4.

In the illustrated example of FIG. 9, when a fault manifests in the power converter 100, a sensor monitoring for the fault (the temperature sensor 802, the amplifier 122, etc.) provides a sensor signal to the fault logic circuitry 808. As described above, the fault logic circuitry 808 also monitors the supply status signal provided by the amplifier 804. Responsive to an asserted sensor signal and asserted supply status signal, the controller 104 of FIG. 9 operates similarly to the controller 104 of FIG. 4. For example, the controller 104 disables the high-side FET 106 and the low-side FET 108 and couples the second input of the selection circuitry 404 to the feedback voltage (V_{Feedback}). In the illustrated example of FIG. 9, responsive to an asserted sensor signal and de-asserted supply status signal, the controller 104 of FIG. 9 operates similarly to the controller 104 of FIG. 8 with the addition of toggling the soft start switch 902 similarly as described in FIG. 4.

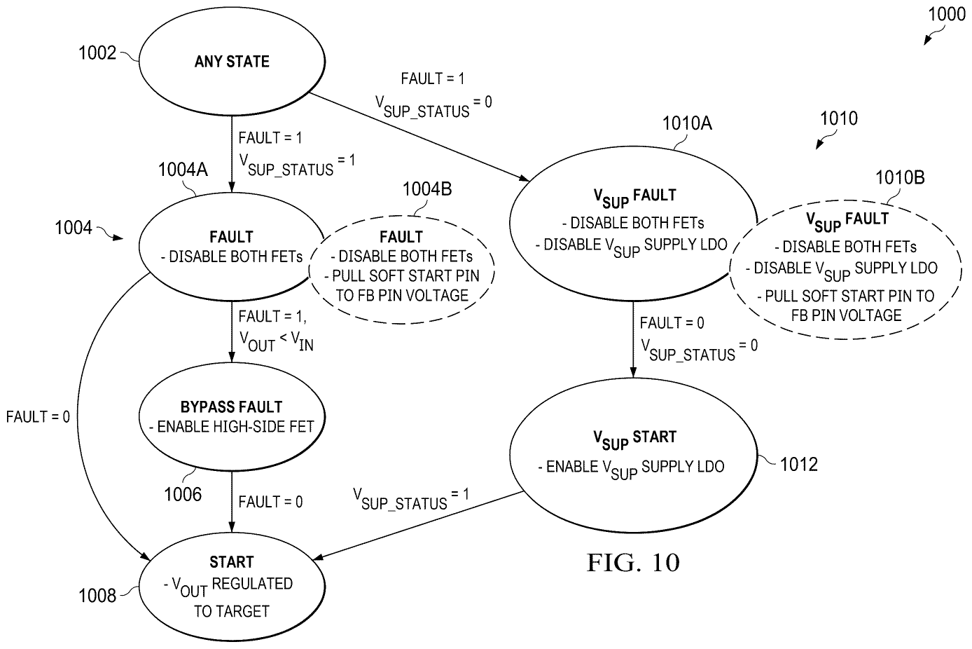

FIG. 10 is an example state diagram 1000 depicting example states of operation of the controller 104 of FIG. 8 or 9. In the example of FIG. 10, the state diagram 1000 includes a first example state 1002, a second example state 1004, a third example state 1006, a fourth example state 1008, a fifth example state 1010, and a sixth example state 1012. Also, the state 1004 includes a first example sub-state 1004A corresponding to the controller 104 of FIG. 8 and a second example sub-state 1004B corresponding to the controller 104 of FIG. 9. In the example of FIG. 10, the state 1010 includes a third example sub-state 1010A corresponding to the controller 104 of FIG. 8 and a fourth example sub-state 1010B corresponding to the controller 104 of FIG. 9.

In the illustrated example of FIG. 10, the state diagram 1000 begins at the state 1002 which is representative of any state of operation of the controller 104. For example, the state 1002 represents normal operation (non-fault operation) of the controller 104. In the example of FIG. 10, in the state 1002, the controller 104 regulates the high-side FET 106 and the low-side FET 108 to step-up the input voltage (V_{IN}) to a target output voltage (V_{OUT}) based on the reference voltage (V_{REF}) at the reference voltage terminal 146. In the example of FIG. 10, the controller 104 transitions from the state 1002 to the state 1010 when a fault manifests and the supply status signal is de-asserted.

In the illustrated example of FIG. 10, the controller 104 transitions from the state 1002 to the state 1004 when a fault manifests and the supply status signal is asserted. For example, responsive to an asserted sensor signal (from the temperature sensor 802, from the amplifier 122, etc.) and an asserted supply status signal, the fault logic circuitry 808 asserts the fault signal. Responsive to the asserted fault signal, the controller 104 transitions to the state 1004. In the example of FIG. 10, the state 1004 is a fault state in which the controller 104 stops regulating the high-side FET 106 and the low-side FET 108.

In the example sub-state 1004A, the controller 104 disables the high-side FET 106 and the low-side FET 108. For example, responsive to the asserted fault signal from the fault logic circuitry 808, the control logic circuitry 138 de-asserts a first control signal and provides the first control signal to the driver 140. Responsive to the de-asserted first control signal, the driver 140 disables the high-side FET 106 and the low-side FET 108. In the sub-state 1004B, the controller 104 pulls the soft start pin of the controller 104 to the voltage at the feedback pin of the controller 104 in addition to disabling the high-side FET 106 and the low-side FET 108.

For example, responsive to the asserted fault signal, the soft start switch 902 couples the second input of the selection circuitry 904 and the first terminal of the capacitor 906 to the second terminal of the resistor 134, the first terminal of the resistor 136, and the second input of the amplifier 130. Depending on the conditions of the power converter 100, the controller 104 transitions from the state 1004 to the state 1006 or to the state 1008. In the example of FIG. 10, the controller 104 transitions from the state 1004 to the state 1008 when the fault clears. For example, responsive to a de-asserted sensor signal (from the temperature sensor 802, from the amplifier 122, etc.), the fault logic circuitry 808 de-asserts the fault signal. Responsive to the de-asserted fault signal, the controller 104 transitions to the state 1008.

In the illustrated example of FIG. 10, the controller 104 transitions from the state 1004 to the state 1006 when the output voltage (V_{OUT}) from the power converter 100 falls below the input voltage (V_{IN}) to the power converter 100 while a fault is present. For example, while a fault is present (the fault signal is asserted), the fault logic circuitry 808 asserts the fault bypass signal responsive to an asserted transistor protection signal from the amplifier 806 (indicating that the output voltage is less than the input voltage). Responsive to the asserted fault bypass signal, the controller 104 transitions to the state 1006. In the example of FIG. 10, the state 1006 is a fault bypass state in which the controller 104 enables the high-side FET 106 in the forward direction to prevent the high-side FET 106 from being damaged.

For example, responsive to the asserted fault bypass signal from the fault logic circuitry 808, the control logic circuitry 138 asserts a second control signal and provides the second control signal to the driver 140. Responsive to the asserted second control signal, the driver 140 enables the high-side FET 106 in the forward direction. As such, the high-side FET 106 is not reverse biased even though the output voltage (V_{OUT}) from the power converter 100 was less than the input voltage (V_{IN}) to the power converter 100. Thus, the high-side FET 106 does not dissipate power to a level that could damage the high-side FET 106.

In the illustrated example of FIG. 10, the controller 104 transitions from the state 1006 to the state 1008 when the fault clears. For example, responsive to a de-asserted sensor signal (from the temperature sensor 802, from the amplifier 122, etc.) while in the state 1006, the fault logic circuitry 808 de-asserts the fault signal. Responsive to the de-asserted fault signal from the fault logic circuitry 808, the controller 104 transitions to the state 1008. For example, responsive to the de-asserted fault signal, the control logic circuitry 138 de-asserts the second control signal and provides the second control signal to the driver 140. Responsive to the de-asserted second control signal, the driver 140 disables the high-side FET 106 and the controller 104 returns to normal control of the high-side FET 106 and the low-side FET 108 as described herein.

As described above, in some examples, the controller 104 transitions from the state 1002 to the state 1010. For example, the controller 104 transitions from the state 1002 to the state 1010 when a fault manifests and the supply status signal is de-asserted. Responsive to an asserted sensor signal (from the temperature sensor 802, from the amplifier 122, etc.) and a de-asserted supply status signal, the fault logic circuitry 808 asserts the fault signal and de-asserts the enable signal. Responsive to the asserted fault signal and the de-asserted enable signal, the controller 104 transitions to the state 1010. In the example of FIG. 10, the state 1010 is a supply fault state in which the controller 104 stops providing the supply voltage (V_{SUP}) and stops regulating the high-side FET 106 and the low-side FET 108.

In the example sub-state 1010A, the controller 104 disables the voltage regulator 142 and disables the high-side FET 106 and the low-side FET 108. For example, responsive to the de-asserted enable signal from the fault logic circuitry 808, the voltage regulator 142 disables. Also, for example, responsive to the asserted fault signal from the fault logic circuitry 808, the control logic circuitry 138 de-asserts a first control signal and provides the first control signal to the driver 140. Responsive to the de-asserted first control signal, the driver 140 disables the high-side FET 106 and the low-side FET 108.

In the illustrated example of FIG. 10, in addition to disabling the voltage regulator 142, the high-side FET 106, and the low-side FET 108, the controller 104 also pulls the soft start pin of the controller 104 to the voltage at the feedback pin of the controller 104 in the sub-state 1010B. For example, responsive to the asserted fault signal, the soft start switch 902 couples the second input of the selection circuitry 904 and the first terminal of the capacitor 906 to the second terminal of the resistor 134, the first terminal of the resistor 136, and the second input of the amplifier 130. In the example of FIG. 10, the controller 104 transitions from the state 1010 to the state 1012 when the fault clears and the supply status signal is de-asserted.

For example, while the supply status signal is de-asserted, the fault logic circuitry 808 de-asserts the fault signal responsive to a de-asserted sensor signal (from the temperature sensor 802, from the amplifier 122, etc.). Responsive to the de-asserted fault signal, the controller 104 transitions to the state 1012. For example, responsive to the de-asserted sensor signal, the fault logic circuitry 808 de-asserts the fault signal and asserts the enable signal. In the state 1012, the voltage regulator 142 enables. For example, responsive to the asserted enabled signal, the voltage regulator 142 enables and provides the supply voltage (V_{SUP}) to the driver 140.

In the illustrated example of FIG. 10, responsive to an asserted supply status signal, the controller 104 transitions from the state 1012 to the state 1008. In the state 1008, the controller 104 returns to normal control of the high-side FET 106 and the low-side FET 108. For example, the amplifier 128 compares the slope compensated sensed current signal provided by the mixer 124 to the error signal provided by the amplifier 130. Based on the comparison, the amplifier 128 generates a PWM signal and provides the PWM signal to the control logic circuitry 138. Responsive to the PWM signal, the control logic circuitry 138 provides a control signal to the driver 140.

Responsive to the control signal, the driver 140 controls one or more of the high-side FET 106 or the low-side FET 108. As such, the controller 104 regulates the high-side FET 106 and the low-side FET 108 to step up the input voltage (V_{IN}) to a target output voltage (V_{OUT}) based on the voltage at the first input of the amplifier 130. In the controller 104 of FIG. 8, the voltage at the first input of the amplifier 130 is the reference voltage (V_{REF}) and in the controller 104 of FIG. 9, the voltage at the first input of the amplifier 130 varies depending on which of the voltage across the capacitor 906 (V_{SoftStart}) and the reference voltage (V_{REF}) is larger.

For example, the selection circuitry 904 switches the voltage at the first input of the amplifier 130 from the voltage across the capacitor 906 (V_{SoftStart}) to the reference voltage (V_{REF}) when the voltage across the capacitor 906 (V_{SoftStart}) exceeds the reference voltage (V_{REF}). In the controller 104 of FIG. 9, the rate at which the capacitor 906 charges from the feedback voltage (V_{Feedback}) to the supply voltage (V_{SUP}) is based on the capacitance of the capacitor 906 and an internal current source of the selection circuitry 904 until the voltage across the capacitor 906 (V_{SoftStart}) meets the reference voltage (V_{REF}). Thus, the slew rate at which the power converter 100 steps up to the target output voltage (V_{OUT}) is based on the capacitance of the capacitor 906.

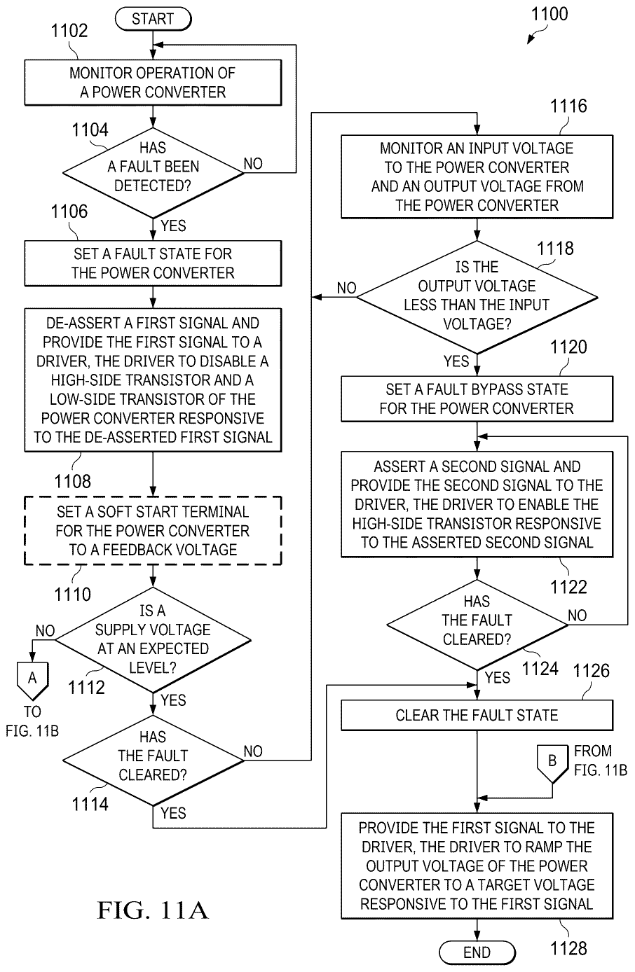

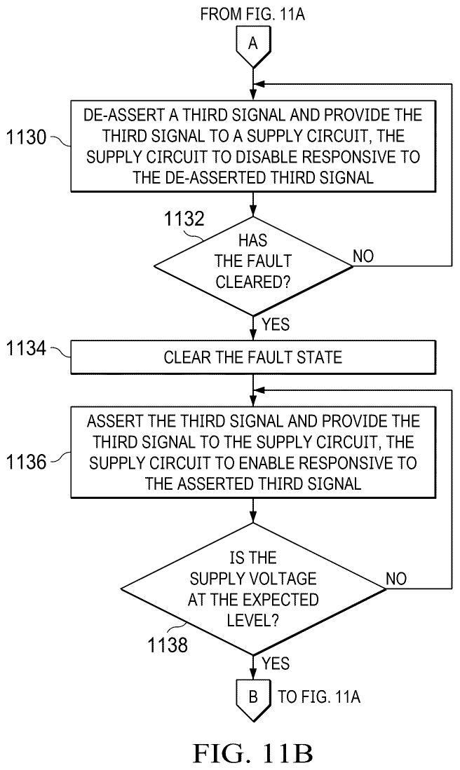

FIG. 11 is a flowchart representative of at least one of example machine-readable instructions or example operations 1100 that may be at least one of executed, instantiated, or performed by programmable circuitry to implement the controller 104 of FIG. 8 or 9. The at least one of the example machine-readable instructions or the example operations 1100 of FIG. 11 begin at block 1102, at which the fault logic circuitry 808 monitors operation of a power converter. For example, the fault logic circuitry 808 monitors operation of the power converter 100 via one or more sensors such as the temperature sensor 802 and the amplifier 122. At block 1104, the fault logic circuitry 808 determines whether a fault has been detected. For example, the fault logic circuitry 808 determines whether an asserted sensor signal has been received indicating that a fault has manifested.

In the illustrated example of FIG. 11, responsive to the fault logic circuitry 808 determining that a fault has not been detected (block 1104: NO), the at least one of the machine-readable instructions or the operations 1100 return to block 1102. Responsive to the fault logic circuitry 808 determining that a fault has been detected (block 1104: YES), the at least one of the machine-readable instructions or the operations 1100 proceed to block 1106. At block 1106, the fault logic circuitry 808 sets a fault state for the power converter. For example, the fault logic circuitry 808 asserts the fault signal. At block 1108, responsive to the set fault state, the control logic circuitry 138 de-asserts a first control signal and provides the first control signal to a driver. Responsive to the de-asserted first control signal, the driver disables a high-side transistor and a low-side transistor of the power converter.

In some examples, the at least one of the machine-readable instructions or the operations 1100 include block 1110. For example, when the at least one of the machine-readable instructions or the operations 1100 are utilized to implement the controller 104 of FIG. 9, the at least one of the machine-readable instructions or the operations 1100 include block 1110. At block 1110, responsive to the set fault state, the soft start switch 902 sets a soft start terminal for the power converter to a feedback voltage. For example, responsive to the asserted fault signal, the soft start switch 902 couples the soft start input of the selection circuitry 904 to the feedback input of the amplifier 130, which receives the feedback voltage (V_{Feedback}).

In the illustrated example of FIG. 11, at block 1112, the amplifier 804 determines whether a supply voltage is at an expected level. For example, the amplifier 804 determines whether a stepped down version of the supply voltage (V_{SUP}) provided by the voltage regulator 142 is greater than or equal to the reference voltage (V_{REF}) at the reference voltage terminal 816. If the amplifier 804 determines that the stepped down version of the supply voltage (V_{SUP}) is greater than or equal to the reference voltage (V_{REF}), the amplifier 804 asserts a supply status signal. Responsive to the amplifier 804 determining that the supply voltage is at an expected level (block 1112: YES), the at least one of the machine-readable instructions or the operations 1100 proceed to block 1114.

In the illustrated example of FIG. 11, at block 1114, the fault logic circuitry 808 determines if the fault has cleared. For example, the fault logic circuitry 808 determines whether an asserted sensor signal is still present. Responsive to the fault logic circuitry 808 determining that the fault has cleared (block 1114: YES), the at least one of the machine-readable instructions or the operations 1100 proceed to block 1126. Responsive to the fault logic circuitry 808 determining that the fault has not cleared (block 1114: NO), the at least one of the machine-readable instructions or the operations 1100 proceed to block 1116. At block 1116, the amplifier 806 monitors an input voltage to the power converter and an output voltage from the power converter.

In the illustrated example of FIG. 11, at block 1118, the amplifier 806 determines whether the output voltage is less than the input voltage. If the amplifier 806 determines that the output voltage is less than the input voltage, the amplifier 806 asserts a transistor protection signal. Responsive to the amplifier 806 determining that the output voltage is not less than the input voltage (block 1118: NO), the at least one of the machine-readable instructions or the operations 1100 return to block 1116. Responsive to the amplifier 806 determining that the output voltage is less than the input voltage (block 1118: YES), the at least one of the machine-readable instructions or the operations 1100 proceed to block 1120. At block 1120, responsive to the asserted transistor protection signal, the fault logic circuitry 808 sets a fault bypass state for the power converter. For example, the fault logic circuitry 808 asserts the fault bypass signal.

In the illustrated example of FIG. 11, responsive to the set fault bypass state, the control logic circuitry 138 asserts a second control signal and provides the second control signal to the driver at block 1122. Responsive to the asserted second control signal, the driver enables the high-side transistor. As such, the high-side transistor will not be reverse biased and is protected from dissipating power to a level that could damage the high-side transistor. In the example of FIG. 11, at block 1124, the fault logic circuitry 808 determines if the fault has cleared. For example, the fault logic circuitry 808 determines whether an asserted sensor signal is still present. Responsive to the fault logic circuitry 808 determining that the fault has not cleared (block 1124: NO), the at least one of the machine-readable instructions or the operations 1100 return to block 1122.

In the illustrated example of FIG. 11, responsive to the fault logic circuitry 808 determining that the fault has cleared (block 1124: YES), the at least one of the machine-readable instructions or the operations 1100 proceed to block 1126. At block 1126, the fault logic circuitry 808 clears the fault state. For example, the fault logic circuitry 808 de-asserts the fault signal. At block 1128, responsive to the cleared fault state, the control logic circuitry 138 provides the first signal to the driver and the driver ramps the output voltage of the power converter to a target voltage responsive to the first signal. For example, responsive to the cleared fault state, the control logic circuitry 138 de-asserts the second control signal and the driver disables the high-side transistor responsive to the de-asserted second control signal. As such, the power converter returns to normal operation based on the first control signal.

As described above, when the at least one of the machine-readable instructions or the operations 1100 are utilized to implement the controller 104 of FIG. 9, the soft start switch 902 sets the soft start terminal for the power converter to the feedback voltage responsive to a set fault state. For example, responsive to a set fault state, the soft start switch 902 couples the soft start input of the selection circuitry 904 to the feedback input of the amplifier 130, which receives the feedback voltage. Likewise, responsive to a cleared fault state, the soft start switch 902 decouples the soft start input of the selection circuitry 904 from the feedback input of the amplifier 130 and couples the soft start input to the supply voltage terminal 908. Thus, the capacitor 906 charges to the supply voltage (V_{SUP}). As described above, the slew rate at which the power converter 100 steps up to the target output voltage (V_{OUT}) is based on the capacitance of the capacitor 906 when the at least one of the machine-readable instructions or the operations 1100 are utilized to implement the controller 104 of FIG. 9.

Returning to block 1112, if the amplifier 804 determines that the stepped down version of the supply voltage (V_{SUP}) is less than the reference voltage (V_{REF}), the amplifier 804 de-asserts a supply status signal. Responsive to the amplifier 804 determining that the supply voltage is not at an expected level (block 1112: NO), the at least one of the machine-readable instructions or the operations 1100 proceed to block 1130. At block 1130, responsive to the de-asserted supply status signal, the fault logic circuitry 808 de-asserts a third signal and provides the third signal to a supply circuit. For example, the fault logic circuitry 808 de-asserts the enable signal. Responsive to the de-asserted third signal, the supply circuit disables.

As such, circuits operating based on a supply voltage provided by the supply circuit are disabled. For example, because the driver operates based on the supply voltage, the driver is disabled. At block 1132, the fault logic circuitry 808 determines if the fault has cleared. For example, the fault logic circuitry 808 determines whether an asserted sensor signal is still present. Responsive to the fault logic circuitry 808 determining that the fault has not cleared (block 1132: NO), the at least one of the machine-readable instructions or the operations 1100 return to block 1130. Responsive to the fault logic circuitry 808 determining that the fault has cleared (block 1132: YES), the at least one of the machine-readable instructions or the operations 1100 proceed to block 1134.

In the illustrated example of FIG. 11, at block 1134, the fault logic circuitry 808 clears the fault state. For example, the fault logic circuitry 808 de-asserts the fault signal. As described above, the driver is disabled because the driver operates based on the supply voltage, which is disabled while the third signal is de-asserted. Thus, despite the fault state being cleared, the driver cannot control the high-side transistor or the low-side transistor of the power converter regardless of the state of a control signal from the control logic circuitry 138. In the example of FIG. 11, at block 1136, the fault logic circuitry 808 asserts the third signal and provides the third signal to the supply circuit. For example, the fault logic circuitry 808 asserts the enable signal. Responsive to the asserted third signal, the supply circuit enables.

In the illustrated example of FIG. 11, at block 1138, the amplifier 804 determines whether the supply voltage is at the expected level. For example, the amplifier 804 determines whether the stepped down version of the supply voltage (V_{SUP}) is greater than or equal to the reference voltage (V_{REF}). If the amplifier 804 determines that the stepped down version of the supply voltage (V_{SUP}) is greater than or equal to the reference voltage (V_{REF}), the amplifier 804 asserts the supply status signal. Responsive to the amplifier 804 determining that the supply voltage is at the expected level (block 1138: YES), the at least one of the machine-readable instructions or the operations 1100 return to block 1128. Responsive to the amplifier 804 determining that the supply voltage is not at the expected level (block 1138: NO), the at least one of the machine-readable instructions or the operations 1100 return to block 1136.

As described above, at block 1128, the control logic circuitry 138 provides the first signal to the driver and the driver ramps the output voltage of the power converter to a target voltage responsive to the first signal. For example, responsive to the supply voltage returning to the expected value, the driver can control one or more of the high-side transistor or the low-side transistor of the power converter responsive a control signal from the control logic circuitry 138. Thus, responsive to the supply voltage returning to the expected value, the power converter returns to normal operation based on the first control signal.

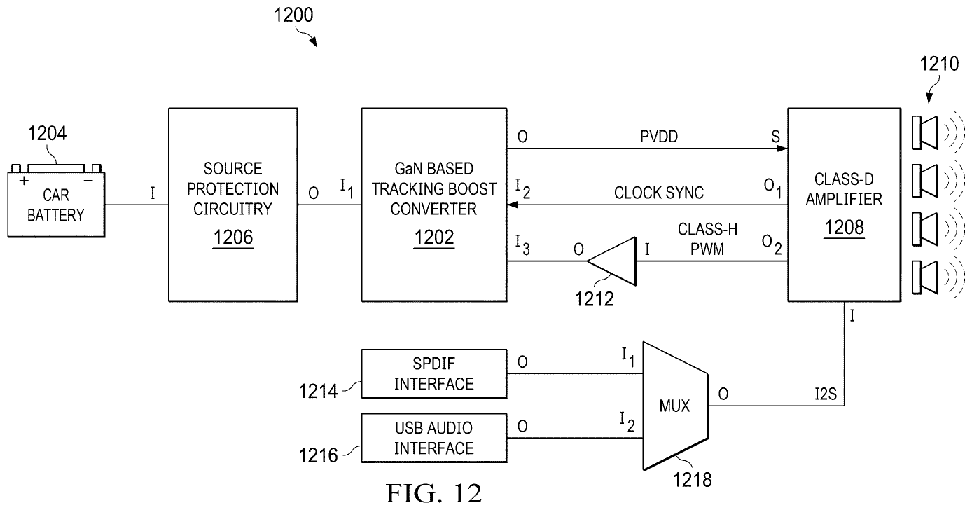

FIG. 12 is a block diagram of an example system 1200 including an example power converter 1202. In the example of FIG. 12, the system 1200 includes the power converter 1202, an example power source 1204, example source protection circuitry 1206, a first example amplifier 1208, and an example output device 1210. Also, the system 1200 of FIG. 12 includes a second example amplifier 1212, an example Sony/Philips digital interface (SPDIF) 1214, an example universal serial bus (USB) interface 1216, and an example multiplexer 1218. In the example of FIG. 12, the power converter 1202 has a first input, a second input, a third input, and an output and each of the source protection circuitry 1206 and the amplifier 1212 has an input and an output. Also, the amplifier 1208 has a supply terminal, an input, a first output, and a second output and each of the SPDIF 1214 and the USB interface 1216 has an output. The multiplexer 1218 has a first input, a second input, and an output.

In the illustrated example of FIG. 12, the first input of the power converter 1202 is coupled to the output of the source protection circuitry 1206, the second input of the power converter 1202 is coupled to the first output of the amplifier 1208, and the third input of the power converter 1202 is coupled to the output of the amplifier 1212. In the example of FIG. 12, the output of the power converter 1202 is coupled to the supply terminal of the amplifier 1208. Also, the input of the source protection circuitry 1206 is coupled to the power source 1204 and the output of the source protection circuitry 1206 is coupled to the first input of the power converter 1202 as described above.

In the illustrated example of FIG. 12, the supply terminal of the amplifier 1208 is coupled to the output of the power converter 1202 and the input of the amplifier 1208 is coupled to the output of the multiplexer 1218. In the example of FIG. 12, the first output of the amplifier 1208 is coupled to the second input of the power converter 1202 and the second output of the amplifier 1208 is coupled to the input of the amplifier 1212. Also, a third output of the amplifier 1208 is coupled to an input of the output device 1210.

In the illustrated example of FIG. 12, the output of the SPDIF 1214 is coupled to the first input of the multiplexer 1218 and the output of the USB interface 1216 is coupled to the second input of the multiplexer 1218. In the example of FIG. 12, the first input of the multiplexer 1218 is coupled to the output of the SPDIF 1214 and the second input of the multiplexer 1218 is coupled to the output of the USB interface 1216. Also, the output of the multiplexer 1218 is coupled to the input of the amplifier 1208.

In the illustrated example of FIG. 12, the power source 1204 is a car battery. For example, the power source 1204 is a 12V battery in a vehicle. In the example of FIG. 12, the source protection circuitry 1206 is implemented by circuitry such as resistors, diodes, and capacitors to limit current, suppress voltage spikes, and block reverse currents associated with the power source 1204. Also, the power converter 1202 of FIG. 12 is a GaN-based boost converter. For example, the power converter 1202 is implemented by the power converter 100 of FIG. 1. In the example of FIG. 12, the amplifier 1208 is an audio amplifier such as a class-D amplifier.

In the illustrated example of FIG. 12, each of the SPDIF 1214 and the USB interface 1216 can receive an audio signal. In the example of FIG. 12, the multiplexer 1218 selects between an audio signal provided by the SPDIF 1214 and the USB interface 1216 responsive to a control signal from a controller (not illustrated). Responsive to the control signal, the multiplexer 1218 provides an audio signal to the amplifier 1208 on an inter-IC sound (I2S) bus. In the example of FIG. 12, the amplifier 1208 receives the audio signal from the multiplexer 1218 and amplifies the audio signal before providing the audio signal to the output device 1210. For example, the output device 1210 is a speaker.

In the illustrated example of FIG. 12, the amplifier 1208 analyzes the audio signal from the multiplexer 1218 to determine the required voltage to amplify the audio signal. Based on the analysis, the amplifier 1208 provides a class-H PWM signal to the amplifier 1212. For example, the class-H PWM signal, when amplified, will cause the power converter 1202 to provide the required voltage to amplify the audio signal. In the example of FIG. 12, the amplifier 1212 amplifies the class-H PWM signal and provides the amplified class-H PWM signal to the power converter 1202. Also, the amplifier 1212 provides a clock signal (Clock_Sync) to the power converter 1202.

In the illustrated example of FIG. 12, the power converter 1202 is a GaN-based tracking boost converter. For example, responsive to the clock signal and the amplified class-H PWM signal, the power converter 1202 steps up the voltage of the power source 1204 and provides a power signal (P_{VDD}) to the amplifier 1208. As such, the amplifier 1208 can amplify the audio signal received from the multiplexer 1218 and provide the amplified audio signal to the output device 1210.

In the event that a fault arises, a controller of the power converter 1202 disables the power converter 1202. In some examples, the power converter 1202 flags a fault to downstream devices such as the amplifier 1208. For example, downstream devices can utilize an internal protection circuit to handle a fault. Also or alternatively, downstream devices are capable of withstanding currents or voltages associated with the fault. In the example of FIG. 12, the power converter 1202 monitors the input voltage to the power converter 1202 (at the first input) and the output voltage from the power converter 1202 (at the output). As described herein, when the output voltage falls below the input voltage, the power converter 1202 enables a high-side GaN FET of the power converter 1202 in the forward direction to prevent the high-side GaN FET from being damaged.

While the example of FIG. 12 depicts a particular application of the fault controller circuitry 144, or, more generally, the controller 104 of FIG. 1, the fault controller circuitry 144 or the controller 104 may be utilized in a variety of applications. For example, as described above, power converters such as boost converters can be used in a variety of applications including battery-powered devices, solar power systems, and LED drivers. Other applications include voltage stabilizers and start-stop applications. In additional or alternative examples, the fault controller circuitry 144, or, more generally, the controller 104 of FIG. 1 can be used in half-bridges, motor drives, and as a protection feature of a GaN FET, among others.

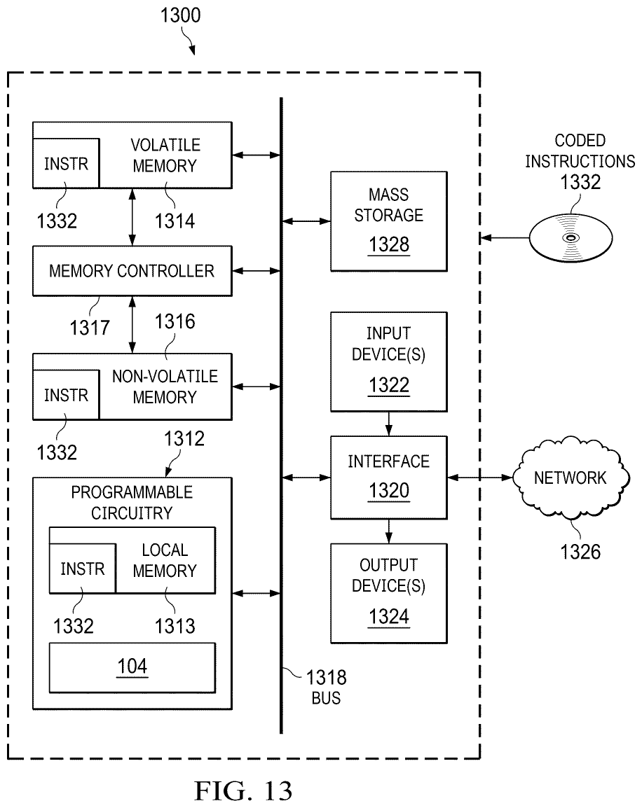

FIG. 13 is a block diagram of an example programmable circuitry platform 1300 structured to one or a combination of execute or instantiate one or more of the example machine-readable instructions or the example operations of FIG. 7 or 11 to implement controller 104 of any of FIGS. 1, 2, 4, 8, or 9. The programmable circuitry platform 1300 can be, for example, a server, a personal computer, a workstation, a self-learning machine (e.g., a neural network), a mobile device (e.g., a cell phone, a smart phone, a tablet such as an iPad™), a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, or microcontrollers from any desired family or manufacturer. The programmable circuitry 1312 may be implemented by one or more semiconductor based (e.g., silicon based) devices. In this example, the programmable circuitry 1312 implements the example controller 104 of FIG. 1.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1316 may be implemented by one or a combination of flash memory or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter one of or a combination of data or commands into the programmable circuitry 1312. The input device(s) 1322 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1324 are also connected to the interface circuitry 1320 of the illustrated example. The output device(s) 1324 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1320 of the illustrated example, thus, includes one of or a combination of a graphics driver card, a graphics driver chip, or graphics processor circuitry such as a GPU.

The interface circuitry 1320 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store one or more of firmware, software, or data. Examples of such mass storage discs or devices 1328 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1332, which may be implemented by the machine-readable instructions of FIG. 7 or 11, may be stored in one of or a combination of the mass storage device 1328, in the volatile memory 1314, in the non-volatile memory 1316, or on at least one non-transitory computer-readable storage medium such as a CD or DVD which may be removable.

While example manners of implementing the controller 104 of FIG. 1 are illustrated in FIGS. 1, 2, 4, 8, and 9, one or more of the elements, processes, or devices illustrated in FIGS. 1, 2, 4, 8, and 9 may be combined, divided, re-arranged, omitted, eliminated, or implemented in any other way. Further, the example controller 104 of any of FIGS. 1, 2, 4, 8, or 9, may be implemented by hardware alone or by hardware in combination with software and firmware. Thus, for example, the example controller 104, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example controller 104 of any of FIGS. 1, 2, 4, 8, or 9 may include one or more elements, processes, or devices in addition to, or instead of, those illustrated in FIGS. 1, 2, 4, 8, and 9, or may include more than one of any or all of the illustrated elements, processes and devices.

Flowchart(s) representative of example machine-readable instructions, which may be executed by programmable circuitry to at least one of implement or instantiate the controller 104 of any of FIGS. 1, 2, 4, 8, or 9 or representative of example operations which may be performed by programmable circuitry to at least one of implement or instantiate the controller 104 of any of FIGS. 1, 2, 4, 8, or 9, are shown in FIG. 7 or 11. The machine-readable instructions may be one or more executable programs or portion(s) of one or more executable programs for execution by programmable circuitry such as the programmable circuitry 1312 shown in the example programmable circuitry platform 1300 described below in connection with FIG. 13 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more non-transitory computer-readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer-readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with at least one of a human user or a machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIG. 7 or 11, many other methods of implementing the example controller 104 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete analog circuitry, discrete digital circuitry, integrated analog circuitry, integrated digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine-executable instructions. For example, the machine-readable instructions may be fragmented and stored on one or more storage devices, disks, or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to render them directly readable, interpretable, or executable by a computing device or other machine. For example, the machine-readable instructions may be stored in multiple parts, which are individually compressed, encrypted, or stored on separate computing devices, where the parts when decrypted, decompressed, or combined form a set of one or more computer-executable or machine-executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer-readable, or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, C-Sharp, etc.

As mentioned above, the example operations of FIG. 7 or 11 may be implemented using executable instructions (e.g., at least one of computer-readable or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer-readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer-readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer-readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the description (e.g., within a claim) in which the elements might, for example, otherwise share a same name.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” may include (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry may be understood as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as at least one of voltage sources or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description.

As used herein, “about,” “approximately,” and “substantially” modify their subjects/values to recognize the potential presence of variations that occur in real world applications. For example, “about,” “approximately,” and “substantially” may modify dimensions or values that may not be exact due to at least one of manufacturing tolerances or other real-world imperfections. Unless otherwise stated, “about,” “approximately,” or “substantially” preceding a value means +/−10 percent of the stated value, or, if the value is zero, a reasonable range of values around zero.

From the foregoing, it will be appreciated that example systems, apparatus, articles of manufacture, and methods have been described for GaN DC-DC converter fault protection. For example, in case of a fault, described systems, apparatus, articles of manufacture, and methods protect the high-side FET of a power converter from excessive power dissipation by enabling the high-side FET after the output voltage from the power converter falls below the input voltage to the power converter, in the case of a boost converter.

For smooth fault exit behavior, examples described herein clamp the soft-start pin of a power converter to an equivalent value of the output voltage during a fault. When the fault is cleared, examples described herein ramp the output voltage up to a target voltage as defined by a capacitor coupled to the soft-start pin. Described examples also monitor internal supply voltages of a controller to distinguish between fault behavior.

Described systems, apparatus, articles of manufacture, and methods improve the efficiency of using a computing device by preventing damage to power FETs during faults, reducing disturbance in the output voltage from a power converter when exiting a fault, and reducing the inrush current to a load when exiting a fault. Also, when implementing examples described herein, system-design is simplified as no component external to the power converter are required to protect the high-side FET from being damaged during a fault. Described systems, apparatus, articles of manufacture, and methods are also directed to one or more improvement(s) in the operation of a machine such as a computer or other electronic, electromechanical, or mechanical device.

Modifications are possible in the described examples, and other examples are possible, within the scope of the claims.

What is claimed is:

1. A power converter controller comprising:
a driver having a first input and a second input;
a comparator having a first input coupled to an output voltage feedback terminal, a second input coupled to an input voltage terminal, and an output; and
logic circuitry having a fault input, a second input coupled to the output of the comparator, a first output coupled to the first input of the driver, and a second output coupled to the second input of the driver, the logic circuitry capable of:
receiving, at the fault input, a first signal that indicates a fault event, and responsively providing a first control signal to the driver to disable a transistor of a power converter;
receiving a second signal from the comparator indicating an input voltage of the power converter exceeds an output voltage of the power converter; and
responsive to the first signal and to the second signal, providing a second control signal to the driver to enable the transistor of the power converter.

2. The power converter controller of claim 1, further comprising overcurrent detection circuitry having an output coupled to the fault input.

3. The power converter controller of claim 2, wherein the comparator is a first comparator, and the overcurrent detection circuitry comprises:
a second comparator having a first input coupled to a first sense terminal, a second input coupled to a second sense terminal, and an output coupled to the fault input.

4. The power converter controller of claim 1, further comprising overtemperature detection circuitry having an output coupled to the fault input.

5. The power converter controller of claim 4, wherein the overtemperature detection circuitry comprises a temperature sensor.

6. The power converter controller of claim 1, wherein the comparator is a first comparator, and the power converter controller further comprises:
a second comparator having a first input coupled to a supply voltage terminal, a second input coupled to a reference voltage terminal, and an output coupled to a supply status input of the logic circuitry.

7. The power converter controller of claim 1, wherein the logic circuitry is first logic circuitry, the comparator is a first comparator, and the power converter controller further comprises:
a second comparator having a first input, a second input, and an output, the first input of the second comparator coupled to a sense terminal, the output of the second comparator coupled to a third input of the logic circuitry;
an amplifier having a first input, a second input, and an output, the first input of the amplifier coupled to the output voltage feedback terminal, the output of the amplifier coupled to the second input of the second comparator;
second logic circuitry having a first input, a second input, and an output, the first input of the second logic circuitry coupled to a reference voltage terminal, the second input of the second logic circuitry coupled to a soft start terminal, the output of the second logic circuitry coupled to the second input of the amplifier; and
third logic circuitry having a first input coupled to a third output of the first logic circuitry, a second input coupled to a supply voltage terminal, a third input coupled to the output voltage feedback terminal, and an output coupled to the second input of the second logic circuitry.

8. The power converter controller of claim 1, wherein the comparator is a first comparator, and the power converter controller further comprises:
a second comparator having a first input coupled to a first sense terminal, a second input coupled to a second sense terminal, and an output;
slope compensation circuitry having an output;
a mixer having a first input coupled to the output of the second comparator, a second input coupled to the output of the slope compensation circuitry, and an output;
a third comparator having a first input, a second input, and an output, the first input of the third comparator coupled to the output of the mixer, the output of the third comparator coupled to a third input of the logic circuitry; and
an amplifier having a first input coupled to a reference voltage terminal, a second input coupled to the output voltage feedback terminal, and an output coupled to the second input of the third comparator.

9. The power converter controller of claim 8, further comprising overtemperature detection circuitry having an output coupled to the fault input.

10. The power converter controller of claim 9, wherein the logic circuitry is first logic circuitry, and the power converter controller further comprises:
second logic circuitry having a first input, a second input, and an output, the first input of the second logic circuitry coupled to the reference voltage terminal, the second input of the second logic circuitry coupled to a soft start terminal, the output of the second logic circuitry coupled to the first input of the amplifier; and
third logic circuitry having a first input coupled to a third output of the first logic circuitry, a second input coupled to a supply voltage terminal, a third input coupled to the output voltage feedback terminal, and an output coupled to the second input of the second logic circuitry.

11. The power converter controller of claim 10, the reference voltage terminal is a first reference voltage terminal, and the power converter controller further comprises a fourth comparator having a first input coupled to the supply voltage terminal, a second input coupled to a second reference voltage terminal, and an output coupled to a supply status input of the logic circuitry.

12. A power converter circuit comprising:
a first transistor having a control terminal, a first terminal, and a second terminal;
a second transistor having a control terminal, a first terminal coupled to the second terminal of the first transistor, and a second terminal coupled to a first reference voltage terminal; and
a controller having a first output coupled to the control terminal of the first transistor and a second output coupled to the control terminal of the second transistor, the controller comprising:
a driver having a first input, a second input, a first output coupled to the control terminal of the first transistor, and a second output coupled to the control terminal of the second transistor;
control logic circuitry having a first input, a second input, a third input, a first output coupled to the first input of the driver, and a second output coupled to the second input of the driver;
fault logic circuitry having an input, a first output coupled to the first input of the control logic circuitry, and a second output coupled to the second input of the control logic circuitry;
a first comparator having a first input coupled to an output voltage feedback terminal, a second input coupled to an input voltage terminal, and an output coupled to the input of the fault logic circuitry;
a second comparator having a first input coupled to a first sense terminal, a second input coupled to a second sense terminal, and an output;
slope compensation circuitry having an output;
a mixer having a first input coupled to the output of the second comparator, a second input coupled to the output of the slope compensation circuitry, and an output;
a third comparator having a first input coupled to the output of the mixer, a second input, and an output coupled to the third input of the control logic circuitry; and
an amplifier having a first input coupled to a second reference voltage terminal, a second input coupled to the output voltage feedback terminal, and an output coupled to the second input of the third comparator.

13. The power converter circuit of claim 12, wherein the input of the fault logic circuitry is a first input, and the controller further comprises overtemperature detection circuitry having an output coupled to a second input of the fault logic circuitry.

14. The power converter circuit of claim 13, wherein the overtemperature detection circuitry comprises a temperature sensor.

15. The power converter circuit of claim 13, further comprising:
selection logic circuitry having a first input, a second input, and an output, the first input of the selection logic circuitry coupled to the second reference voltage terminal, the second input of the selection logic circuitry coupled to a soft start terminal, the output of the selection logic circuitry coupled to the first input of the amplifier; and
switch logic circuitry having a first input coupled to the first output of the fault logic circuitry, a second input coupled to a supply voltage terminal, a third input coupled to the output voltage feedback terminal, and an output coupled to the second input of the selection logic circuitry.

16. The power converter circuit of claim 15, wherein the power converter circuit further comprises a fourth comparator having a first input coupled to the supply voltage terminal, a second input coupled to a third reference voltage terminal, and an output coupled to a third input of the fault logic circuitry.

17. A system comprising:
a speaker having an input;
an audio amplifier having an input and an output coupled to the input of the speaker; and
a power converter having an output coupled to the input of the audio amplifier, the power converter comprising:
a first transistor having a control terminal, a first terminal, and a second terminal;
a second transistor having a control terminal, a first terminal coupled to the second terminal of the first transistor, and a second terminal coupled to a reference voltage terminal;
an inductor having a first terminal and a second terminal, the first terminal coupled to the second terminal of the first transistor and the first terminal of the second transistor;
a driver having a first input, a second input, a first output coupled to the control terminal of the first transistor, and a second output coupled to the control terminal of the second transistor;
control logic circuitry having a first input, a second input, a first output coupled to the first input of the driver, and a second output coupled to the second input of the driver;
fault logic circuitry having an input, a first output coupled to the first input of the control logic circuitry, and a second output coupled to the second input of the control logic circuitry; and
a comparator having a first input coupled to an output voltage feedback terminal, a second input coupled to an input voltage terminal, and an output coupled to the input of the fault logic circuitry.

18. The system of claim 17, wherein the input of the fault logic circuitry is a first input, the comparator is a first comparator, and the power converter further comprises:
a temperature sensor having an output coupled to a second input of the fault logic circuitry;
a second comparator having a first input coupled to a first sense terminal, a second input coupled to a second sense terminal, and an output;
slope compensation circuitry having an output;
a mixer having a first input coupled to the output of the second comparator, a second input coupled to the output of the slope compensation circuitry, and an output;
a third comparator having a first input coupled to the output of the mixer, a second input, and an output coupled to a third input of the control logic circuitry; and
an amplifier having a first input coupled to a second reference voltage terminal, a second input coupled to the output voltage feedback terminal, and an output coupled to the second input of the third comparator.

19. The system of claim 18, wherein the power converter further comprises:
selection logic circuitry having a first input, a second input, and an output, the first input of the selection logic circuitry coupled to the second reference voltage terminal, the second input of the selection logic circuitry coupled to a soft start terminal, the output of the selection logic circuitry coupled to the first input of the amplifier; and
switch logic circuitry having a first input coupled to the first output of the fault logic circuitry, a second input coupled to a supply voltage terminal, a third input coupled to the output voltage feedback terminal, and an output coupled to the second input of the selection logic circuitry.

20. The system of claim 19, wherein the power converter further comprises a fourth comparator having a first input coupled to the supply voltage terminal, a second input coupled to a third reference voltage terminal, and an output coupled to a third input of the fault logic circuitry.
